(19) United States
(12) Patent Application Publication
(10) Pub. No.: US 2025/0316966 A1
(43) Pub. Date: Oct. 9, 2025

(54) CABLE STRIPPING ASSEMBLY

(71) Applicant: MILWAUKEE ELECTRIC TOOL CORPORATION, Brookfield, WI (US)

(72) Inventors: Joseph C. ILLG, Grafton, WI (US); Joseph J. PECHSTEIN, West Bend, WI (US); John N. UELMEN, Campbellsport, WI (US); Joseph W. REMSCHAK, Greenfield, WI (US); Justin T. KORNELY, Milwaukee, WI (US)

(21) Appl. No.: 19/098,357

(22) Filed: Apr. 2, 2025

Related U.S. Application Data
(60) Provisional application No. 63/574,471, filed on Apr. 4, 2024.
(60) Provisional application No. 63/718,875, filed on Nov. 11, 2024.

(51) Int. Cl. H02G 1/12

(52) U.S. Cl. CPC H02G 1/1224; H02G 1/1236

(57) ABSTRACT

A cable stripping assembly for removing a cable jacket from a cable, the cable stripping assembly including: a cable stripping tool including a housing including a head and a handle, the head including a central opening defining a central axis and configured to receive a cable, the handle extending from the head, and a motor disposed in the head, the motor having a motor shaft extending along a motor axis that is parallel to the central axis; an adjustable bushing coupled to the head and having a central opening that is in communication with the head of the housing and extends along the central axis, wherein actuation of the motor drives the adjustable bushing to rotate; and a blade mounted to the adjustable bushing and configured to partially extend into the central opening of the adjustable bushing to engage the cable

### CROSS-REFERENCE TO RELATED APPLICATIONS

This application claims priority to co-pending U.S. Provisional Patent Application No. 63/718,875 filed on Nov. 11, 2024, and to co-pending U.S. Provisional Patent Application No. 63/574,471 filed on Apr. 4, 2024, the entire contents of each of which are incorporated herein by reference.

### FIELD OF THE INVENTION

The present invention relates to cable strippers, and more particularly systems and methods for stripping a cable jacket from a sheathed cable.

### BACKGROUND OF THE INVENTION

Electrical cables are commonly used to transfer electrical energy from power sources, such as a power grid, a power plant, and/or a generator. Other cables may be used to transfer an electrical signal from one location to another. Some cables include thick conductive cores surrounded by a network of minor conductors and encased by a cable jacket that facilitates the prevention of interference caused by direct contact with the cable, and that shields the cable from the environment. The combination of the rigidity of the cable jacket and the materials surrounding the core of the cables may make such cables unwieldy and/or difficult to bend or to reshape.

### SUMMARY OF THE INVENTION

The present invention provides, in one aspect, a cable stripping tool assembly including a handle including a battery interface and a head coupled to the handle. The head includes a main body housing a motor, a bushing coupled to the main body, and a depth stop system coupled to the main body. The bushing includes a blade assembly having a blade and a blade adjustment assembly.

In some aspects, the techniques described herein relate to a cable stripping assembly for removing a cable jacket from a cable, the cable stripping assembly including: a cable stripping tool including a housing including a head and a handle, the head including a central opening defining a central axis and configured to receive a cable, the handle extending from the head, and a motor disposed in the head, the motor having a motor shaft extending along a motor axis that is parallel to the central axis; an adjustable bushing coupled to the head and having a central opening that is in communication with the head of the housing and extends along the central axis, wherein actuation of the motor drives the adjustable bushing to rotate; and a blade mounted to the adjustable bushing and configured to partially extend into the central opening of the adjustable bushing to engage the cable.

In some aspects, the techniques described herein relate to a cable stripping assembly for removing a cable jacket from a cable, the cable stripping assembly including: a cable stripping tool including a housing including a head and a handle, the head including a central opening defining a central axis and configured to receive a cable, the handle extending from the head, and a motor disposed in the housing; an adjustable bushing coupled to the head and having a central opening that is in communication with the head of the housing and extends along the central axis, wherein actuation of the motor drives the adjustable bushing to rotate; a blade mounted to the adjustable bushing and configured to partially extend into the central opening of the adjustable bushing to engage the cable; and a depth stop system supported by the head, the depth stop system including a tube that is receivable and movable within the central opening between a first position and an second position, and a clamp assembly configured to lock the tube in the first position and the second position relative to the head.

In some aspects, the techniques described herein relate to a cable stripping assembly for removing a cable jacket from a cable, the cable stripping assembly including: a cable stripping tool including a housing including a head and a handle, the head including a central opening defining a central axis and configured to receive a cable, the handle extending from the head, and a motor disposed in the housing; an adjustable bushing coupled to the head and having a central opening that is in communication with the head of the housing and extends along the central axis, wherein actuation of the motor drives the adjustable bushing to rotate; and a blade mounted to the adjustable bushing and configured to partially extend into the central opening of the adjustable bushing to engage the cable, the blade having a body including a first end, a second end opposite the first end, the second end extending into and movable relative to the central opening, a first leg extending between the first end and the second end, a second leg extending laterally from the first leg, a first cutting edge positioned at the second end and defined by the first leg, the first cutting edge extending in a first plane, and a second cutting edge positioned at the second end and extending from the first cutting edge along the first leg and the second leg, the second cutting edge extending in a second plane that is positioned at a non-perpendicular angle relative to the first plane.

Other features and aspects of the invention will become apparent by consideration of the following detailed description and accompanying drawings.

### BRIEF DESCRIPTION OF THE DRAWINGS

FIG. 1 is a perspective view of a cable stripping assembly according to one embodiment, the cable stripping assembly including a depth stop system and a blade adjustment assembly.

FIG. 2 is a detailed perspective view of a portion the cable stripping assembly of FIG. 1.

FIG. 3 is a cross-sectional view of the portion of the cable stripping assembly of FIG. 2.

FIG. 4 is an exploded view of a tube of the depth stop system of FIG. 1.

FIG. 5 is another cross-sectional view of a portion of the cable stripping assembly of FIG. 1.

FIG. 6 is a detailed perspective view of a locking clamp of the depth stop system of FIG. 1.

FIG. 7 is a cross-sectional view through the locking clamp of FIG. 6.

FIG. 8 is a detailed perspective view of a portion of the depth stop system of FIG. 1.

FIG. 9 is a perspective view of a locking clamp for use with the depth step system of FIG. 1.

FIG. 10 is a perspective view of another locking clamp for use with the depth step system of FIG. 1.

FIG. 11 is a perspective view of another locking clamp for use with the depth step system of FIG. 1.

FIG. 12 is a perspective view of the locking clamp of FIG. 11 with portions removed for clarity.

FIG. 13 is a cross-sectional view of the locking clamp of FIG. 11 relative to the tube of the depth stop system of FIG. 1.

FIG. 14A illustrates a user inserting a cable to be stripped into the cable stripping assembly of FIG. 1.

FIG. 14B illustrates the user advancing the cable through the cable stripping assembly of FIG. 1.

FIG. 14C illustrates the user continuing to advance the cable through the cable stripping assembly of FIG. 1.

FIG. 14D illustrates the user removing the cable stripping assembly of FIG. 1 from the stripped cable.

FIG. 15 is a perspective view of a blade adjustment assembly for use with the cable stripping assembly of FIG. 1.

FIG. 16 is another perspective view of the blade adjustment assembly of FIG. 15 with portions removed for clarity.

FIG. 17 is another perspective view of the blade adjustment assembly of FIG. 15.

FIG. 18 is another perspective view of the blade adjustment assembly of FIG. 15.

FIG. 19 is a perspective view of another blade adjustment assembly for use with the cable stripping assembly of FIG. 1.

FIG. 20 is a cross-sectional view of the blade adjustment assembly of FIG. 19.

FIG. 21 is another cross-sectional view of the blade adjustment assembly of FIG. 19.

FIG. 22 is a perspective view of the blade adjustment assembly of FIG. 19 with portions removed for clarity.

FIG. 23 is another perspective view of the blade adjustment assembly of FIG. 19.

FIG. 24 is a perspective view of a cable stripping assembly according to another embodiment, the cable stripping assembly including a depth stop system and a blade adjustment assembly.

FIG. 25 is another perspective view of the cable stripping assembly of FIG. 24.

FIG. 26 is a perspective view of a portion of the cable stripping assembly of FIG. 24.

FIG. 27A is a cross-sectional view of the cable stripping assembly of FIG. 24.

FIG. 27B is a cross-sectional view of a portion of cable stripping assembly of FIG. 24.

FIG. 27C is another cross-sectional view of a portion of cable stripping assembly of FIG. 24.

FIG. 28 is a perspective view of a portion of the cable stripping assembly of FIG. 24 with portions removed for clarity.

FIG. 29 is a cross-sectional view of a depth stop system of the cable stripping assembly of FIG. 24.

FIG. 30 is a detailed perspective view of a portion of the cable stripping assembly of FIG. 24.

FIG. 31 is a detailed cross-sectional view of a bushing and a portion of the blade adjustment assembly of the cable stripping assembly of FIG. 24.

FIG. 32 is a cross-sectional view of the blade adjustment assembly of FIG. 24 in a first position.

FIG. 33 is a cross-sectional view of the blade adjustment assembly of FIG. 24 in a second position.

FIG. 34 illustrates a perspective view of a blade of the cable stripping assembly of FIG. 24.

FIG. 35 is a perspective view of the blade of FIG. 34.

FIG. 36 is a view from a working end of the blade of FIG. 34.

FIG. 37 is a plan view of the blade of FIG. 34.

FIG. 38 is a detailed plan view of the blade of FIG. 34.

FIG. 39 is another plan view of the blade of FIG. 34.

FIG. 40 is another plan view of the blade of FIG. 34.

FIG. 41 is a detailed perspective view of the blade of FIG. 34.

FIG. 42 is a side view of the blade of FIG. 34.

FIG. 43 is a detailed perspective view of a clamping assembly of the cable stripping assembly of FIG. 24.

FIG. 44 is a detailed perspective view of the clamping assembly of FIG. 43 with portions removed for clarity.

FIG. 45 is a cross-sectional view of the clamping assembly of FIG. 43.

FIG. 46 is a schematic view of another clamping assembly for use with the cable stripping assembly of FIG. 24.

FIG. 47 illustrates a perspective view of a cable stripping assembly according to another embodiment, the cable stripping assembly including a bushing and a blade adjustment assembly.

FIG. 48 is a perspective view of a portion of the cable stripping assembly of FIG. 47.

FIG. 49 is a rear view of the cable stripping assembly of FIG. 47.

FIG. 50 is a cross-sectional view of a portion of the cable stripping assembly of FIG. 47.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

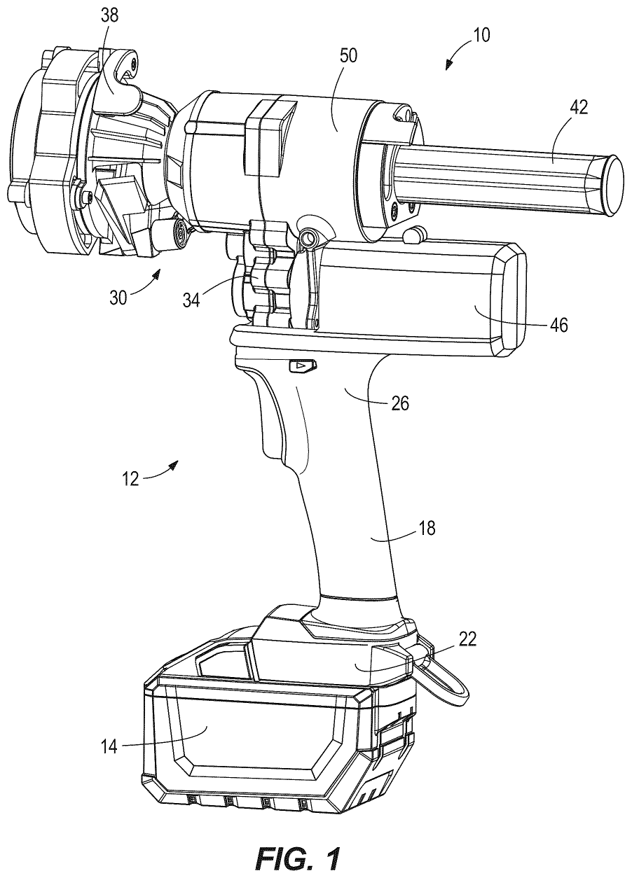

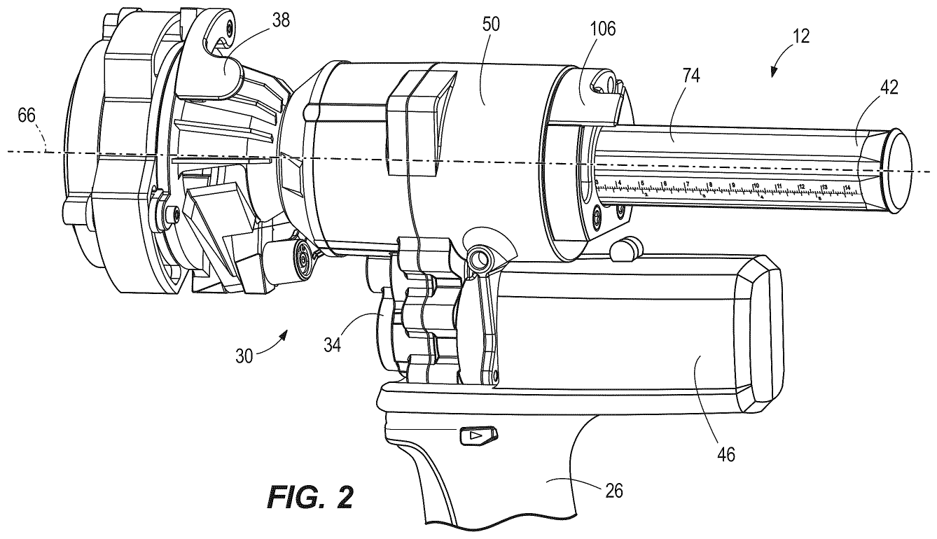

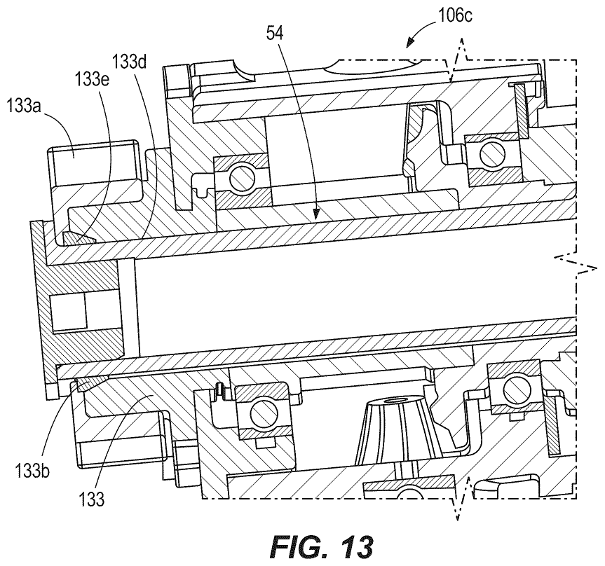

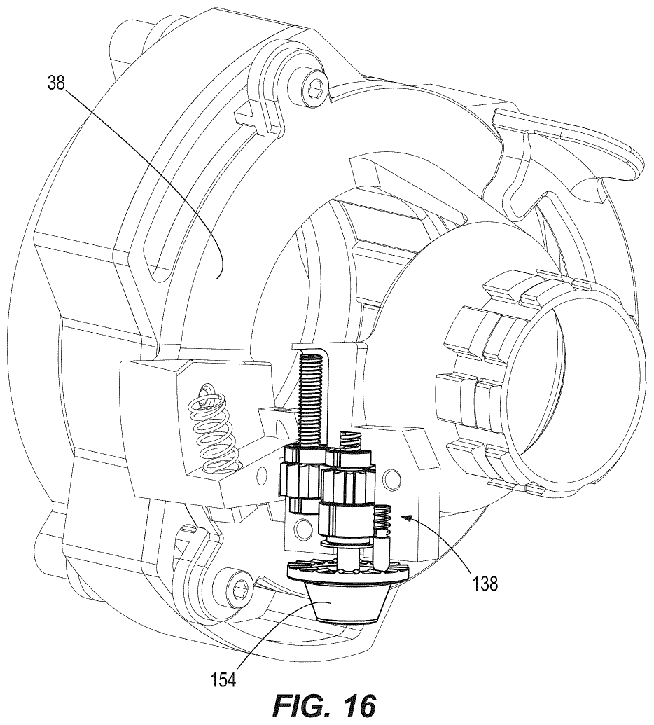

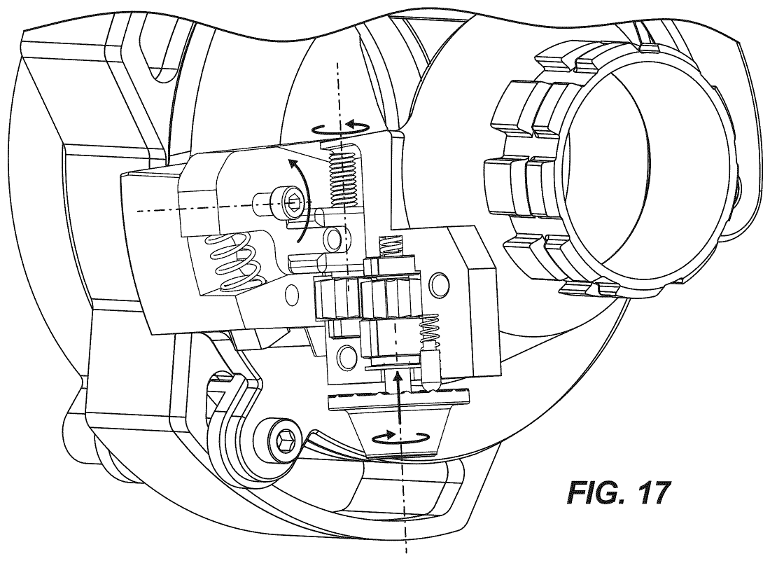

Cables are used to transfer electrical signals and power over long distances and generally include conductors protected by a cable jacket. In order to connect multiple cables for electrical communication therebetween, the conductors are exposed by removing the cable jacket. FIGS. 1-18 illustrate a cable stripping assembly 10 used to remove the cable jacket on cables. The figures illustrate exemplary embodiments of the assembly 10, however, the configuration and components of the assembly 10 are not limited to the embodiments discussed and illustrated herein and may include variations not specifically described.

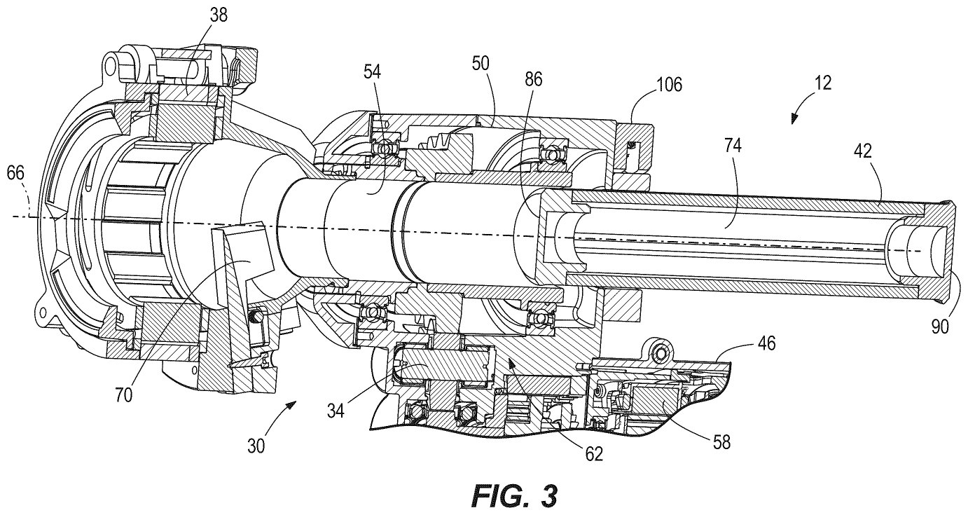

Referring to FIGS. 1-3, the cable stripping assembly 10 includes a cable stripping tool 12 and a battery 14 coupled to the cable stripping tool 12 to provide power thereto. The tool 12 includes a handle 18 extending between a first end 22 and a second end 26, and a head 30 coupled to the second end 26. The first end 22 of the handle 18 includes a battery receiving interface configured to removably couple the battery 14. The head 30 includes a main body 34, an adjustable bushing 38, and a depth stop system 42. The main body 34 includes a motor housing 46 and a pass-through portion 50 defining a central channel 54 (FIG. 3). A motor 58 (FIG. 3) is positioned in the motor housing 46 and is electrically coupled to the battery 14 to transmit rotation to a gear train 62. The adjustable bushing 38 is coupled to the pass-through portion 50 adjacent a front of the head 30. The adjustable bushing 38 is coupled to the gear train 62 such that rotation of the motor 58 is transmitted to the bushing 38 through the gear train 62. A cable end is fed into the adjustable bushing 38 along a channel axis 66 of the central channel 54. The adjustable bushing 38 includes a blade assembly 70 that scores the cable jacket as the tool progresses along the cable.

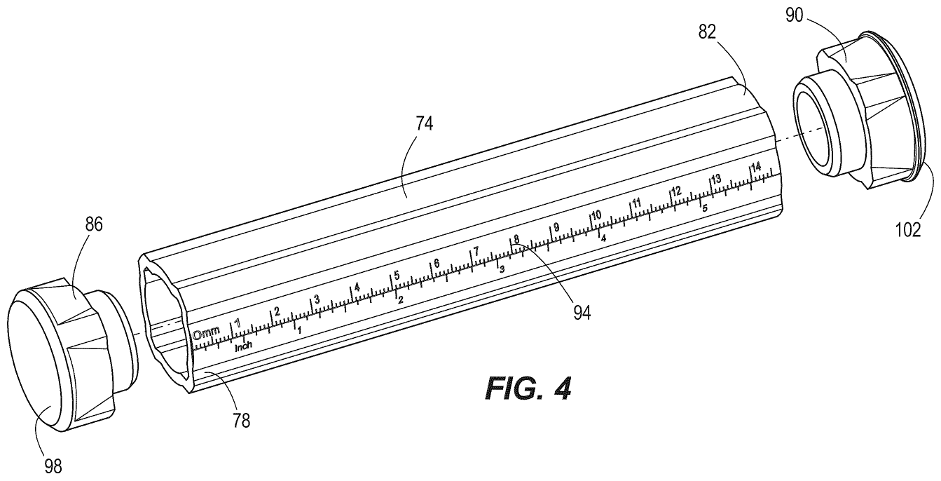

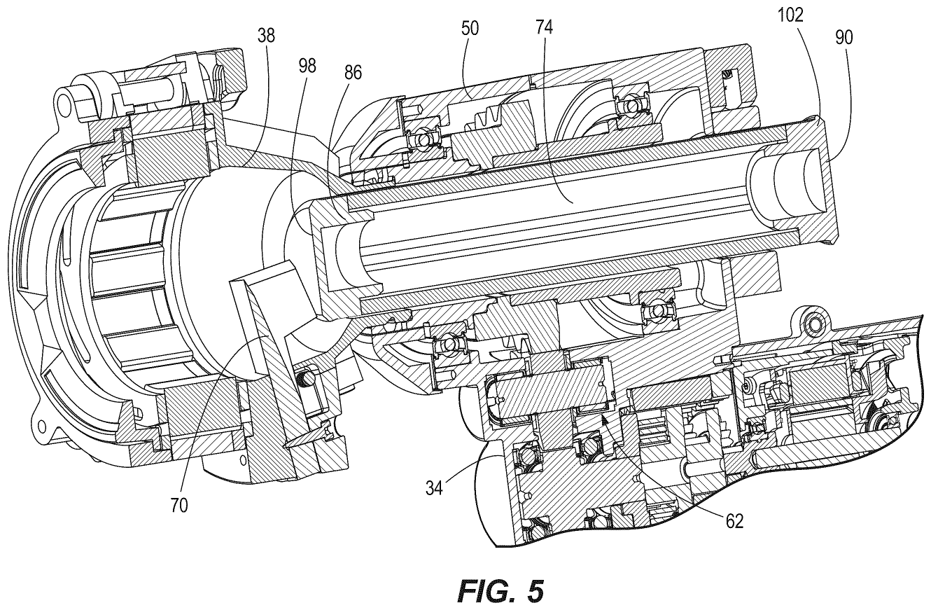

With reference to FIGS. 3-6, the depth stop system 42 is configurable to adjust a strip length of the cable stripping operation (e.g., an amount of the cable jacket that is removed by the tool 12). In other words, the depth stop system 42 limits the distance the cable stripping tool 12 can travel along the cable. With reference to FIG. 4, the depth stop system 42 includes a tube 74 extending along the axis 66 between a front end 78 and a rear end 82, a front plug 86 coupled to the front end 78, and a rear plug 90 coupled to the rear end 82. The tube 74 is positioned to move (e.g., slide) within the central channel 54 along the axis 66 of the central channel 54. The tube 74 slides to a plurality of positions between an extended position, shown in FIG. 3, and a retracted position, shown in FIG. 5. In the retracted position, the front end 78 of the tube 74 and the front plug 86 are adjacent the bushing 38 and most of the tube 74 is received within the central channel 54. In the extended position, the front end 78 of the tube 74 and the front plug 86 are adjacent a rear of the central channel 54 and most of the tube 74 extends rearwardly out of the central channel 54.

With continued reference to FIGS. 3-6, the front plug 86 may be press fit into the front end 78 of the tube 74. The front plug 86 includes a bearing face 98 configured to engage the end of the cable inserted into the tool 12. The front plug 86 may be formed from a durable material, such as steel, in order to withstand wear. The rear plug 90 may be press fit into the rear end 82 of the tube 74. The rear plug 90 may include a flange 102 that engages a rear end of the pass-through portion 50 of the main body 34 to limit the range of movement of the tube 74 along the channel axis 66 so at least a portion of the tube 74 remains outside the central channel 54.

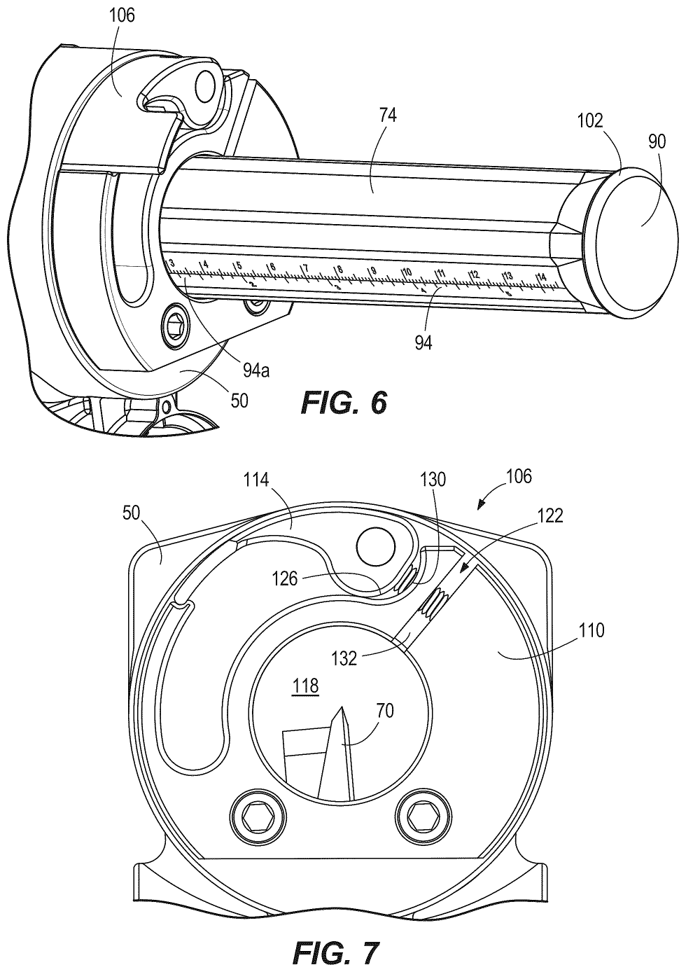

With reference to FIG. 6, the tube 74 may have a non-circular outer profile that engages corresponding features in the main body 34 to prevent rotation of the tube 74 about the axis 66. The tube 74 may be a hollow tube formed from a metal material. The hollow configuration decreases the weight of the tool 12, making it easier for a user to support the tool 12 to engage the cable. In other embodiments, the tube 74 may be otherwise constructed. The tube 74 further includes indicia or markings 94 along the channel axis 66 which indicate a plurality of strip lengths corresponding to the positions of the tube 74. The forward most visible indicia 94a may indicate the strip length obtained with that position of the tube 74. In some embodiments, the tube 74 may be sized to allow for strips between 1 inch and 6 inches. In other embodiments, the tube 74 may be longer or shorter. The tube 74 may be removably coupled to the pass-through portion 50 and may be removed when a longer length of cable needs to be stripped.

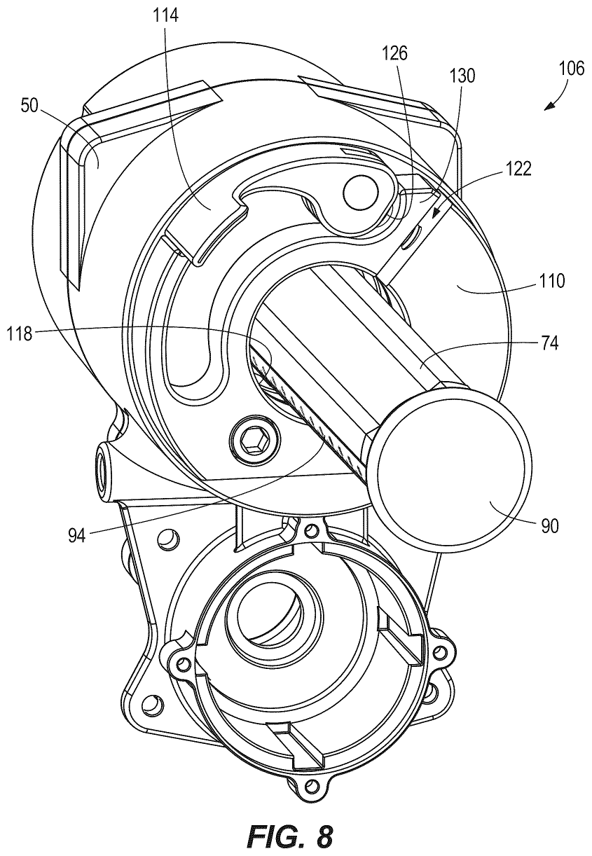

With reference to FIGS. 7-8, the depth stop system 42 further includes a locking clamp 106 configured to engage the tube 74 to secure the position of the tube 74 relative to the central channel 54 and the blade assembly 70. The locking clamp 106 is coupled to the rear end of the pass-through portion 50 of the main body 34. In the illustrated embodiment, the locking clamp 106 includes a clamp body 110 and a lever 114 adjacent the clamp body 110. The clamp body 110 includes a partial ring that surrounds a central opening 118 that receives the tube 74. The partial ring of the clamp body 110 is split by a gap 122, and the clamp body 110 is configured to be deflected to close the gap 122. The lever 114 includes a cam surface 126 configured to engage an end portion 130 of the clamp body 110 adjacent the gap 122. Rotation of the lever 114 results in the cam surface 126 engaging the end portion 130 of the clamp body 110 and closing the gap 122, decreasing the diameter of the central opening 118 and clamping the outside surface of the tube 74. In the illustrated embodiment, the locking clamp 106 includes a spring 132 configured to bias the clamp body 110 into an open or unclamped position, widening the gap 122 and allowing the tube 74 to slide within the central opening 118.

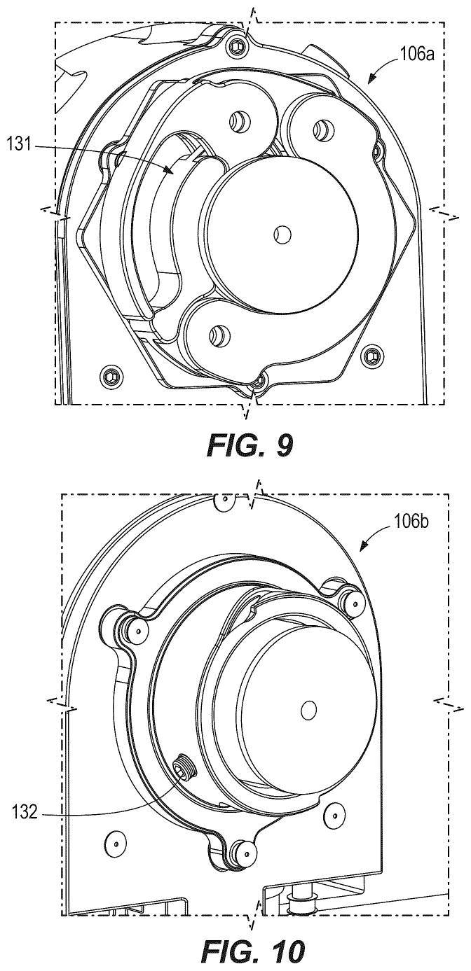

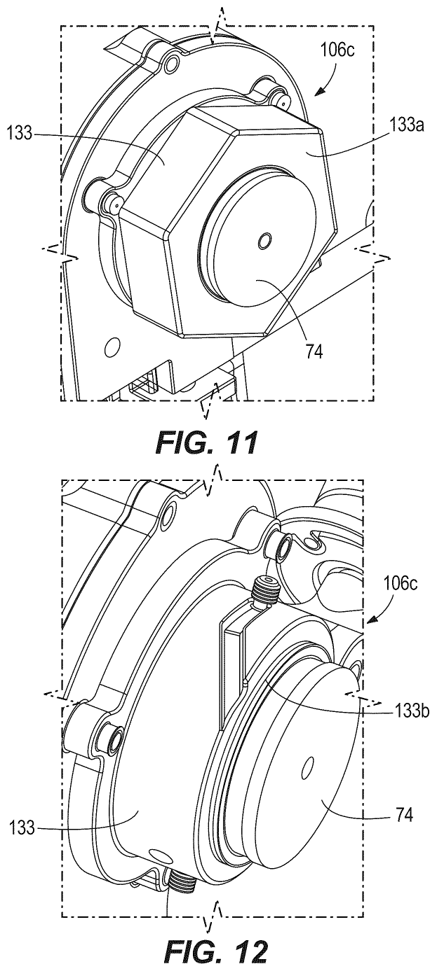

In other embodiments, the locking clamp 106 may use a different mechanism to secure the tube relative to the pass-through portion 50 and the blade assembly 70. For example, in FIG. 9, the locking clamp 106a may include an over-center latching mechanism 131, which when in an open position expands to enable the tube 74 to be movable therethrough and when in closed position secures the tube 74 in a desired position. In FIG. 10, the locking clamp 106b may include a set screw 132 that engages the tube 74. In FIGS. 11-13, the locking clamp 106c may include a support 133 coupled to the pass-through portion 50, a jam nut 133a, and conical washer 133b. The support 133 includes a channel 133d that is communication with the central channel 54. The channel 133d includes an end having a conical surface 133e. The conical washer 133b is matingly received by the conical surface 133e of the channel 133d. The jam nut 133a is rotatable relative to the support 133 to clamp the surfaces of the conical washer 133b against conical surface 133e of the channel 133d. Still further variations may be used to secure the position of the tube and inhibit movement of the tube along the channel axis.

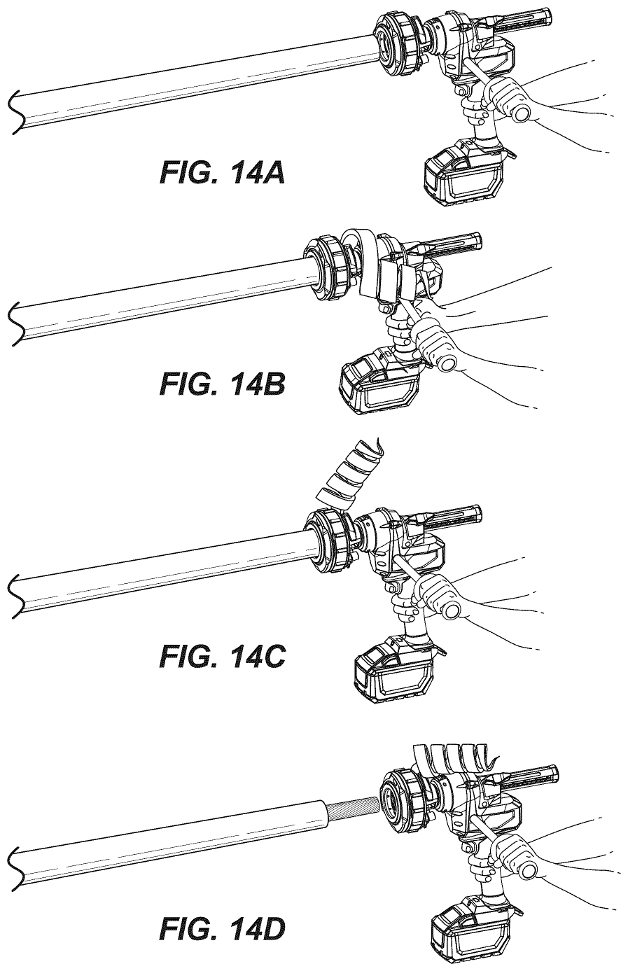

FIGS. 14A-14D illustrate operation of the cable stripping assembly 10 with the depth stop system 42 engaged. As the cable travels into the central channel 54, the blade assembly 70 engages the outer surface of the cable and removes the cable jacket resulting in a spiral scrap exiting the bushing 38. The tool 12 progresses along the cable until the end of the cable engages the bearing face 98 of the front plug 86 of the depth stop system 42. At that point, the tool 12 can be held at the deepest position until the blade assembly 70 has circumferentially scored the cable jacket, resulting in the scrap being detached from the cable and leaving exposed conductors as the tool 12 is removed from the cable end.

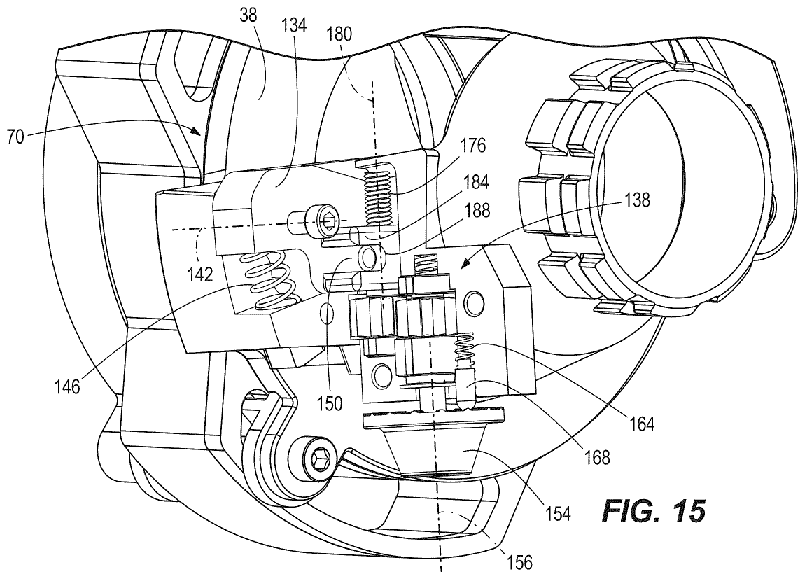

With reference to FIGS. 15-18, the blade assembly 70 may be adjustable and include a blade 134 and a blade adjustment assembly 138 capable of varying a cutting depth of the blade 134 (e.g., a distance between the cutting edge of the blade 134 and the channel axis 66). In the illustrated embodiment, the blade 134 is pivotally coupled to the bushing 38 for rotation about a blade axis 142. A spring 146 pushes against a back end of the blade 134 to bias the blade 134 to rotate toward the channel axis 66. The blade 134 further includes a blade lift pin 150 mounted eccentrically with respect to the blade axis 142. Movement of the blade lift pin 150 causes the blade 134 to rotate about the blade axis 142.

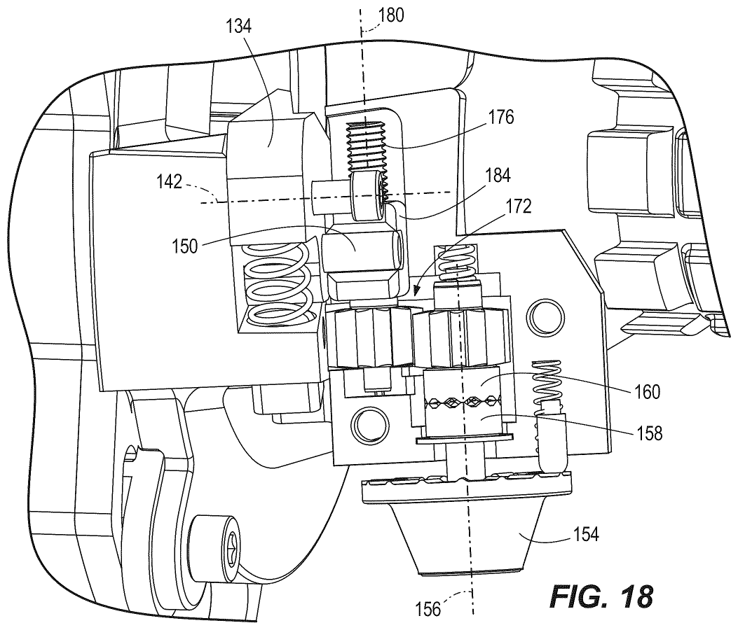

The blade adjustment assembly 138 includes a knob 154 disposed on the outside of the bushing 38 and accessible by an operator. The knob 154 is mounted for rotation about a knob axis 156. The knob 154 is further mounted to translate along the knob axis 156, or in other words, to be pushed in along the knob axis 156. As seen in FIG. 18, the knob 154 includes a knob crown gear 158 mounted thereto. A second crown gear 160 is positioned adjacent the knob 154 such that when the knob 154 is pushed in, the knob crown gear 158 engages the second crown gear 160. A spring 164 may be included to bias the knob 154 to the outer/disengaged position. A detent pin 168 may make an audible noise when the knob 154 is moved to the inner position and the crown gears 158, 160 are engaged. The second crown gear 160 is the first end of an adjustment gear train 172 configured to transfer rotation from the knob 154 to a screw 176. In the illustrated embodiment, the gear train 172 includes multiple gears, and the gears may have a 1:1 ratio. In other embodiments, the gears may change the torque or speed of the rotation as it is transmitted through the gear train 172. In the illustrated embodiment, the gear train 172 reverses rotation provided by the user so movement of the blade 134 is intuitive (e.g., tightening rotation of the knob 154 results in lifting the blade 134 away from the channel axis 66). Additionally, the gear train 172 may include enough gears to create an offset between the screw 176 and the knob 154 to advantageously position the knob 154 relative to the other features of the bushing 38. The screw 176 extends along a screw axis 180 and includes outer threads. A clevis 184 is mounted to the screw 176 and includes an inner threaded profile so rotation of the screw 176 causes linear displacement of the clevis 184 along the screw axis 180. The clevis 184 includes a slot 188 and is mounted so the slot 188 engages the blade lift pin 150 and linear movement of the clevis 184 causes the blade lift pin 150 to rotate the blade 134 about the blade axis 142.

During operation, a user pushes the knob 154 in along the knob axis 156 until the pin 168 is heard, indicating the crown gears 158, 160 are engaged. The user then rotates the knob 154 in the desired direction and rotation is transmitted through the engagement of the crown gears 158, 160 to the adjustment gear train 172, and transmitted to the screw 176. The rotation of the screw 176 causes the clevis 184 to translate along the screw axis 180 and engage the blade lift pin 150 to pivot the blade 134 about the blade axis 142 and change the cutting depth. Once the blade 134 is in the desired position, the knob 154 is either pulled out or released and is biased to travel outward along the knob axis 156 to disengage the crown gears 158, 160. The screw 176 is inhibited from being back driven by the clevis 184. Therefore, pressure applied on the blade 134 by the cable is transferred to the clevis 184 via the blade lift pin 150, and the clevis 184 is held in position by the screw 176 and does not move along the screw axis 180, thereby preventing the blade 134 from rotating about the blade axis 142. Additionally, the spring 164 biases the blade 134 relative to the clevis 184 to inhibit the blade 134 from wiggling within the slot 188 during operation. The knob 154 of the blade adjustment assembly 138 inhibits accidental adjustment of the blade position (e.g., by spiral scrap jacket that exits the bushing 38 or by a user brushing against the knob 154) by requiring the knob 154 be pushed in and held to allow adjustment of the position of the blade 134.

In some circumstances, the blade 134 may need to be removed from the bushing 38. A user may remove the screw acting as a pivot point for the blade 134. The blade 134 can then be lifted away from the bushing 38, as the slot 188 in the clevis 184 allows the blade 134 to be disengaged from the blade adjustment assembly 138 easily. The blade 134 may then be maintained, repaired, or replaced with a new blade.

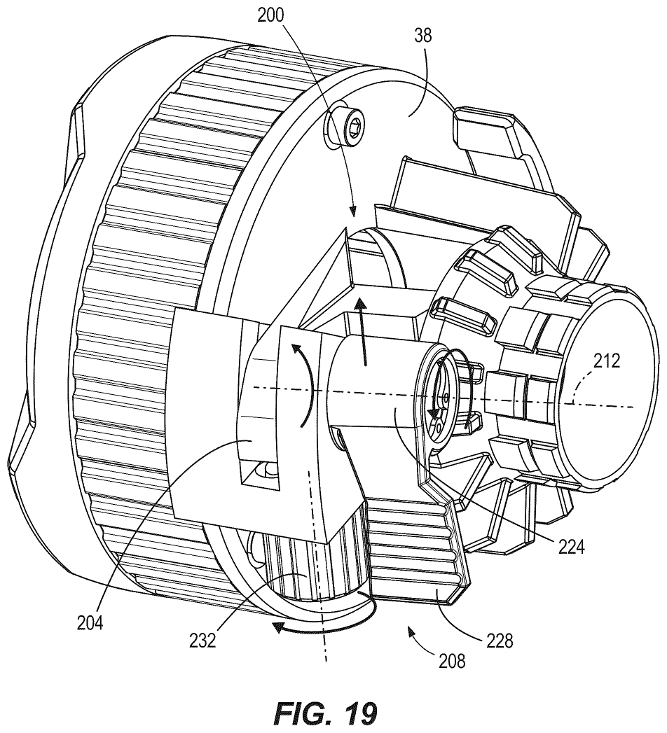

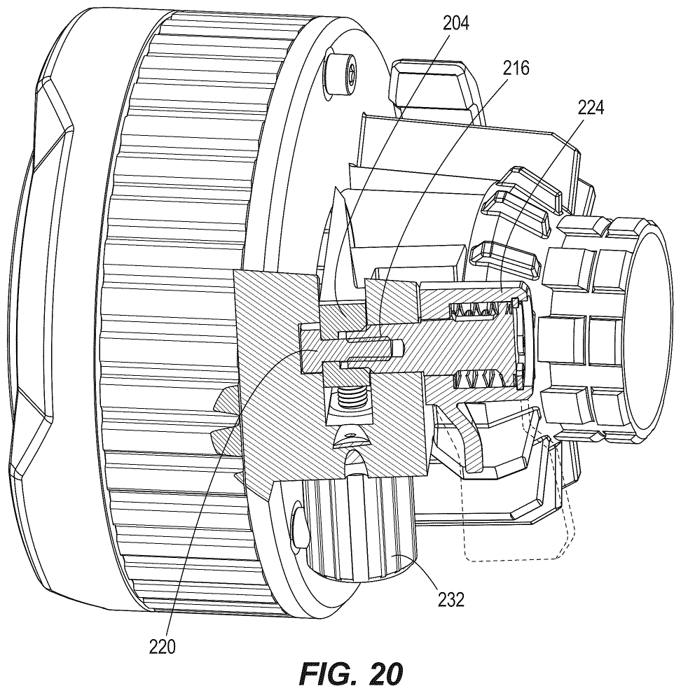

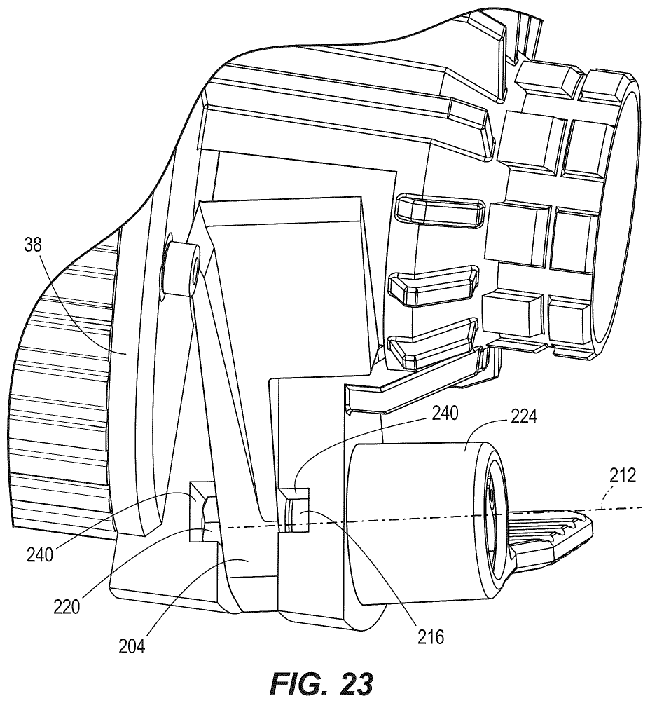

FIGS. 19-23 illustrate an alternative embodiment of a blade assembly 200 including a blade 204 and a blade adjustment assembly 208. The blade 204 is mounted to the bushing 38 for pivoting movement about a blade axis 212. In the illustrated embodiment, the blade 204 is pivotally mounted on a pivot pin 216 that defines the blade axis 212. A nut or flange 220 is positioned at the end of the pivot pin 216, and a locking lever 224 is coupled to the pivot pin 216 on the opposite end of the pivot pin 216. In the illustrated embodiment, the pivot pin 216 is threaded, and the locking lever 224 includes internal threads that engage the threads of the pivot pin 216. Rotation of the locking lever 224 about the pivot pin 216 causes the locking lever 224 to move toward the flange 220, clamping the blade 204 therebetween. Thus, pivoting of the blade 204 is only allowed when the locking lever 224 is moved to an unlocked position. The locking lever 224 includes a lever tab 228 that is sized to provide the needed torque to clamp the blade 204 based on the torque specifications of the pivot pin 216.

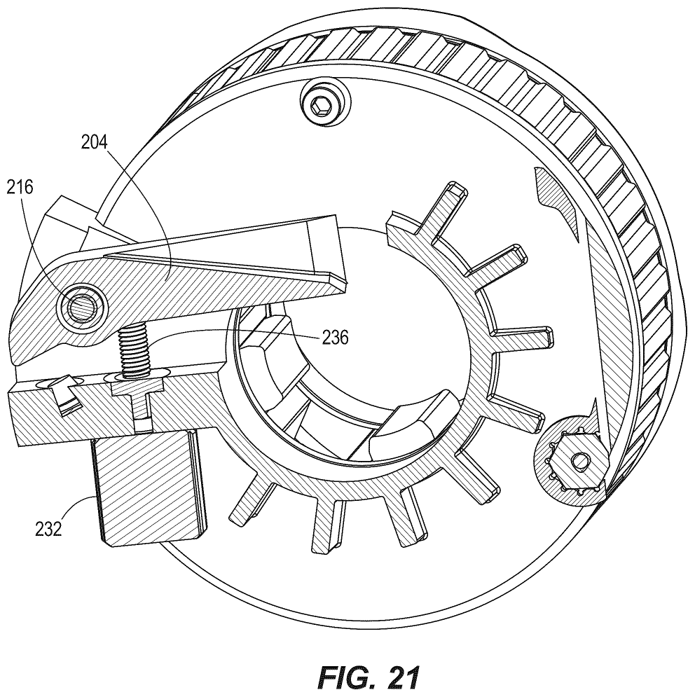

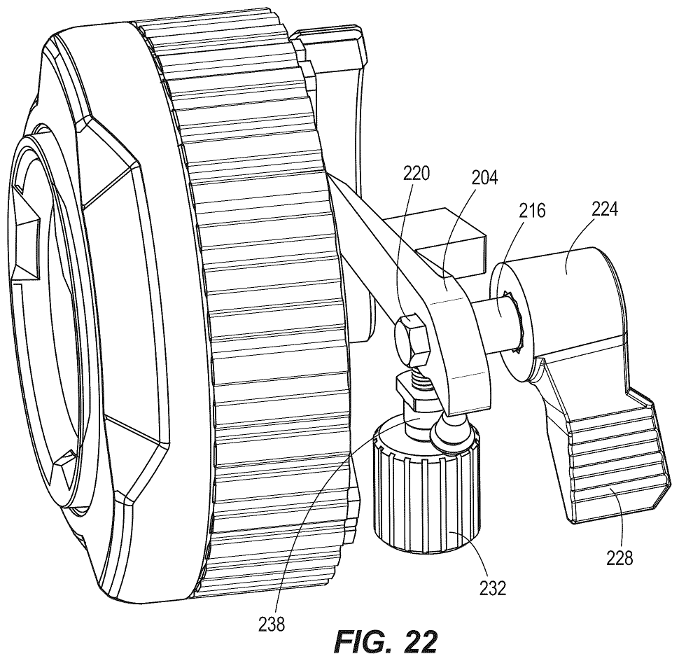

The blade adjustment assembly 208 further includes a dial 232 coupled to a threaded support rod 236 (FIG. 21) mounted on the bushing 38 to travel through a threaded insert 238 (FIG. 22). The support rod 236 engages the blade 204 in one of a plurality of positions. The blade 204 may be biased by a spring (not shown) into engagement with the support rod 236. Rotation of the dial 232 causes linear movement of the threaded support rod 236 relative to the bushing 38, which adjusts the position of the blade 204. The insert 238 supporting the threaded support rod 236 may be formed from steel to prevent wear on the threads. Once the blade 204 is positioned, the locking lever 224 is engaged to clamp the blade 204 in said position. The spring and the threaded support rod 236 provide a secondary support to reduce wiggle or play of the blade 204 during operation.

In the event the blade 204 needs to be removed, for replacement or maintenance, slots 240 are provided on either side of the blade 204 to facilitate removal of the blade 204 and the pivot pin 216. Specifically, the locking lever 224 is rotated and removed from the pivot pin 216 which loosens the clamp on the blade 204. The blade 204 and pivot pin 216 can then be simply lifted out of the slots 240. The pivot pin 216 can then be separated from the blade 204 if needed. The components can be serviced or replaced.

Overall, the blade adjustment assembly of FIGS. 19-23 provides an assembly that securely maintains a position of the blade 204 and prevents inadvertent adjustment of the cutting depth by including a separate clamp (locking lever 224) and adjustment interface (dial 232). The assembly is also easy to operate and maintain.

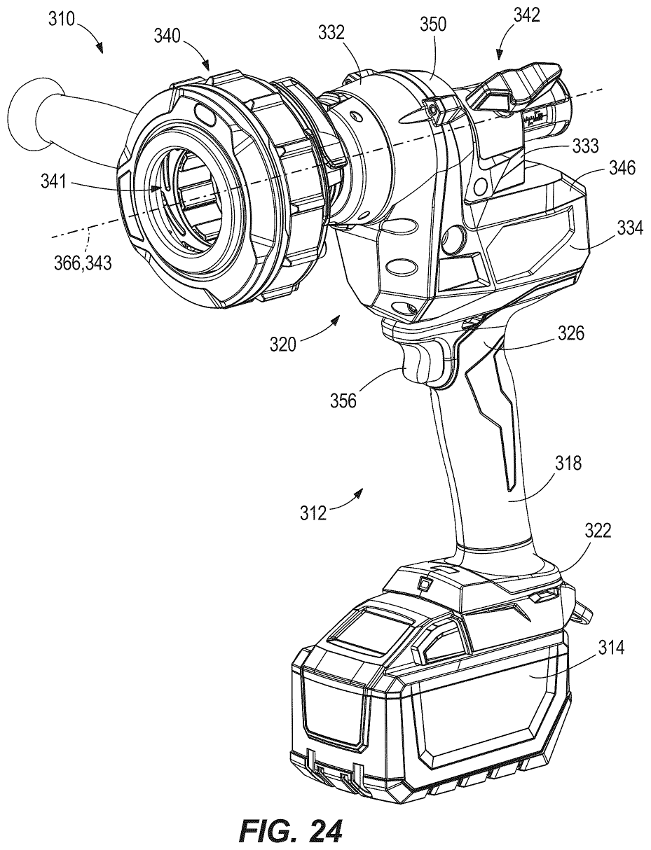

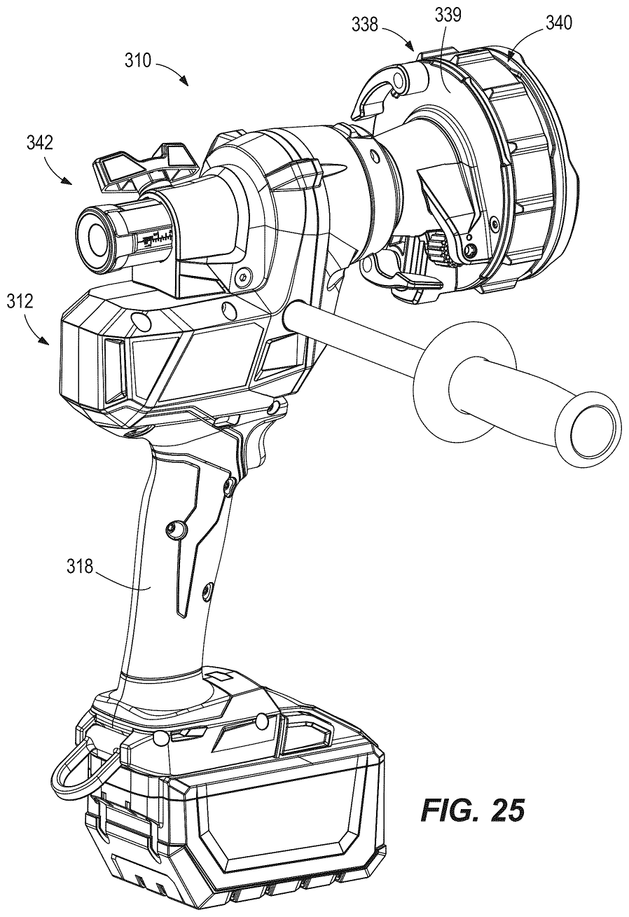

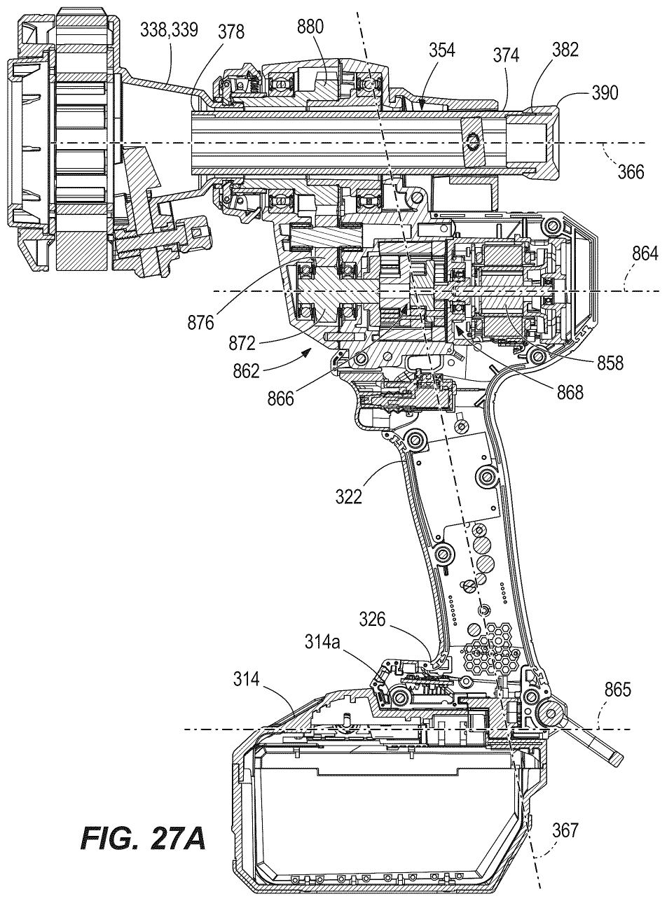

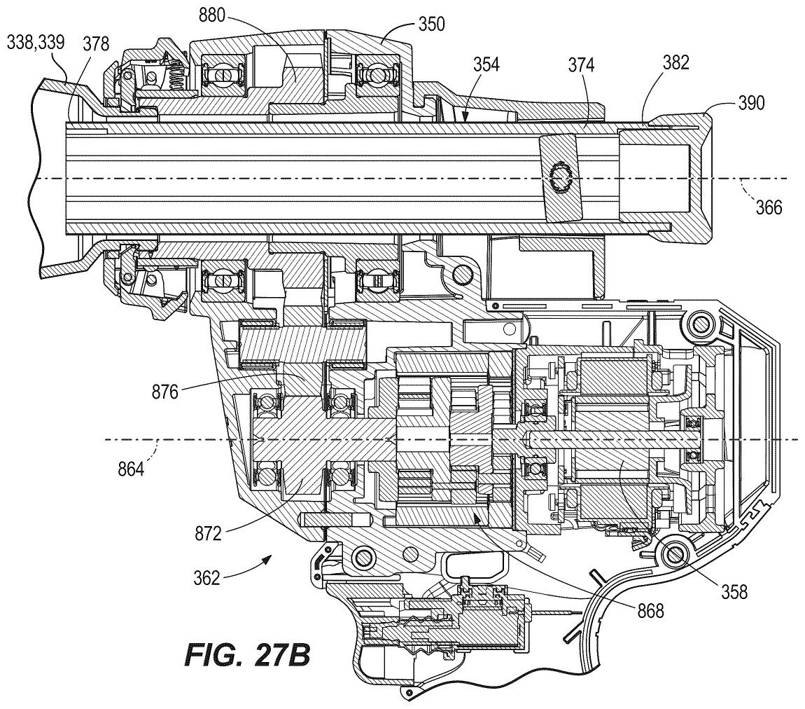

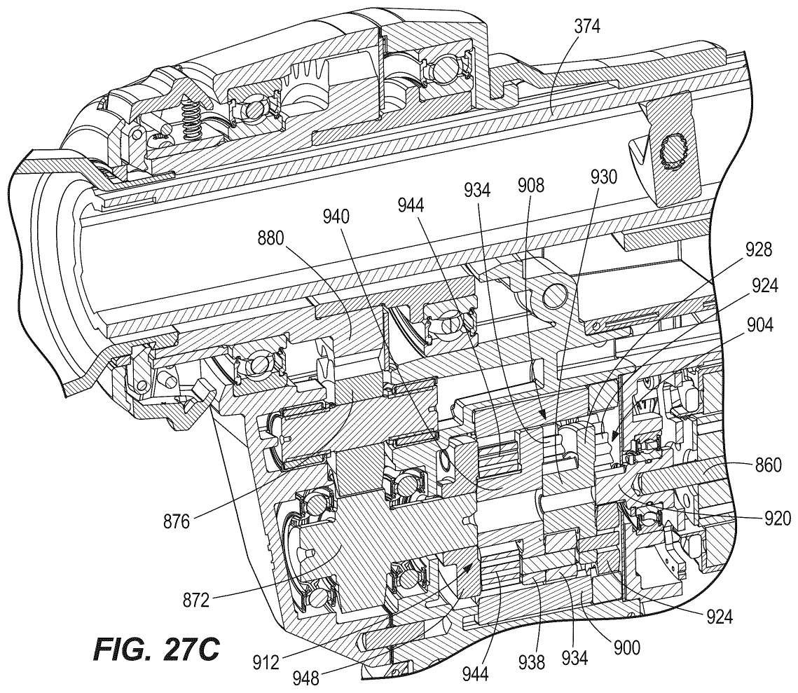

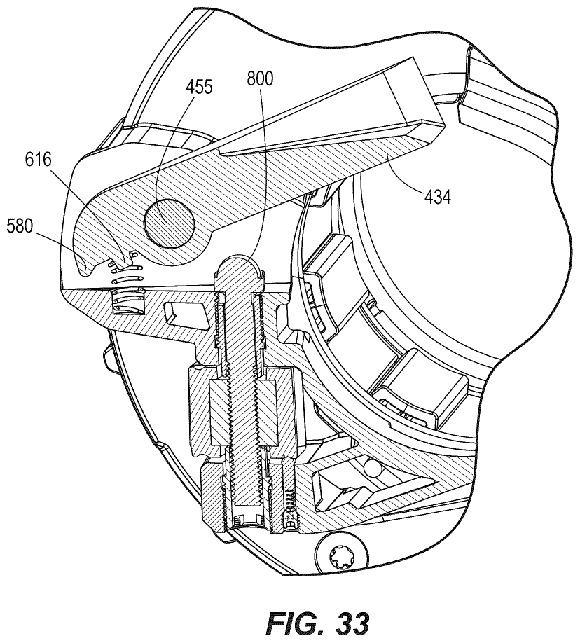

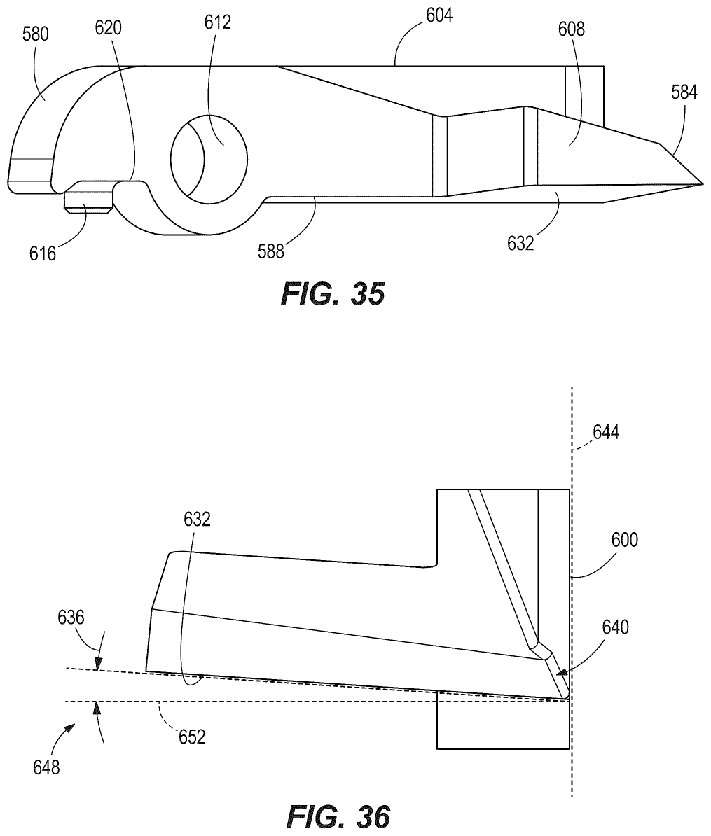

Referring to FIGS. 24-45, a cable stripping assembly 310 according to another embodiment is shown. The cable stripping assembly 310 includes a cable stripping tool 312 and a battery 314 coupled to the cable stripping tool 312 to provide power thereto. The tool 312 includes a handle 318 extending between a first end 322 and a second end 326, and a head 330 coupled to the second end 326. The first end 322 of the handle 318 includes a battery receiving interface 314a configured to removably couple the battery 314. The head 330 includes a front end 332, a rear end 333, a main body 334, an adjustable bushing 338, and a depth stop system 342. The main body 334 includes a motor housing 346 extending between the front end 332 and the rear end 333 and a pass-through portion 350 extending between the front end 332 and the rear end 333. The pass-through portion 350 defines a central channel 354 (FIGS. 27A and 27B) that extends between the front end 332 and the rear end 333. A motor 358 (FIGS. 27A and 27B) is positioned in the motor housing 346 and is actuated by an actuator 356 (e.g., a trigger). The motor 358 is electrically coupled to the battery 14 to transmit rotation to a gear train 362 (FIG. 27B). The adjustable bushing 338 is coupled to the pass-through portion 350 at or adjacent the front end 332 of the head 330. The adjustable bushing 38 is coupled to the gear train 362 such that rotation of the motor 358 is transmitted to the bushing 338 through the gear train 362. A cable end is fed into the adjustable bushing 338 along a channel axis 366 of the central channel 354. The adjustable bushing 338 includes a blade assembly 370 that scores the cable jacket as the tool progresses along the cable.

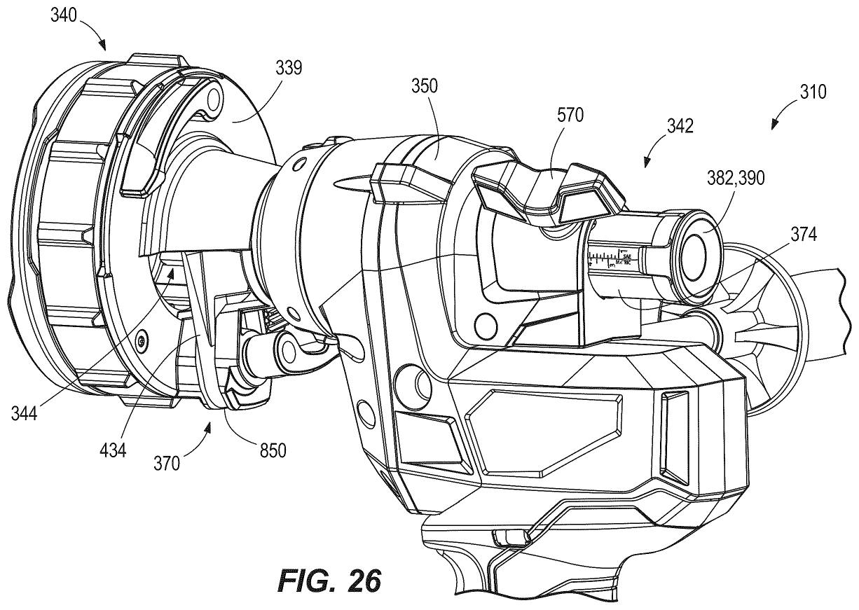

The bushing 338 includes a main body 339, a clamping assembly 340, and a blade assembly 370. The bushing 338 defines a central opening 341 extending therethrough. The central opening 341 is configured to align with the central channel 354 of the pass-through portion 350, such that a central axis 343 extending through the central opening 341 of the bushing 338 is coincident with the channel axis 366. The bushing 338 also includes a side opening 344 (FIG. 26) that is in communication with the central opening 341 and extends laterally through the main body 339. The side opening 344 is configured to guide scrap cable jacket from the central opening 341 outwardly of the bushing 338.

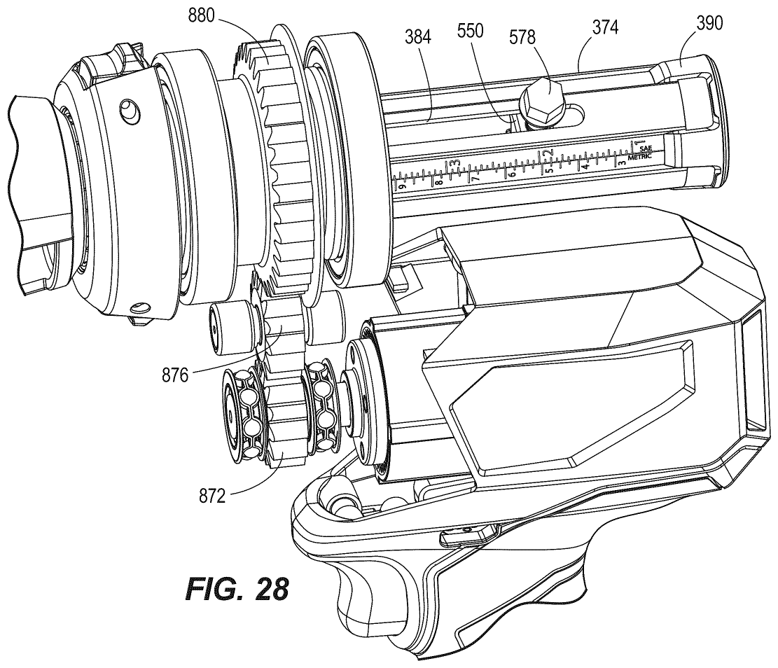

With reference to FIGS. 26-29, the illustrated depth stop system 342 is configurable to adjust a strip length of the cable stripping operation (e.g., an amount of the cable jacket that is removed by the tool 312). In other words, the depth stop system 342 limits the distance the cable stripping tool 312 can travel along the cable. With reference to FIG. 27B, the depth stop system 342 includes a tube 374 extending along the axis 366 between a front end 378 and a rear end 382, a front plug (not shown in FIG. 27B but shown as element 98 in FIG. 4 above) coupled to the front end 378, a rear plug 390 coupled to the rear end 382, and an axial slot 384 (FIG. 28) extending along a portion of the length of the tube 374. The tube 374 is positioned to slide within the central channel 354 along the axis 366 of the central channel. The tube 374 slides to a plurality of positions between an extended position and a retracted position. In the retracted position, the front end 378 of the tube 374 and the front plug are adjacent the bushing 338 and most of the tube 374 is received within the central channel 354. In the extended position, the front end 378 of the tube 374 and the front plug are adjacent a rear of the central channel 354 and most of the tube 374 extends rearwardly out of the central channel 354.

With continued reference to FIGS. 27A-28, the front plug may be press fit into the front end 378 of the tube 374. The front plug includes a bearing face (as discussed above with respect to the depth stop system 42 of FIGS. 3-6) configured to engage the end of the cable inserted into the tool 312. The front plug may be formed from a durable material, such as steel, in order to withstand wear. The rear plug 390 may be press fit into the rear end 382 of the tube 374.

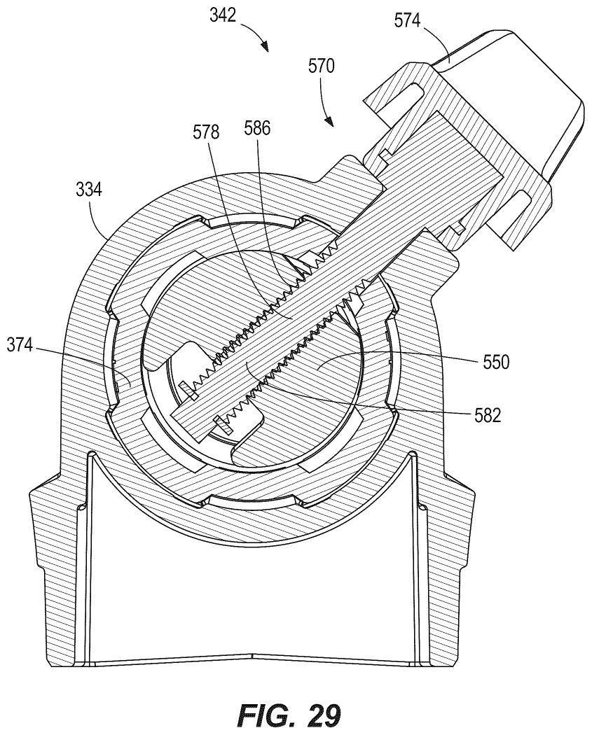

With reference to FIGS. 28 and 29, the tube 374 may have a non-circular outer profile that engages corresponding features in the main body 334 to prevent rotation of the tube 374 about the axis 366. The tube 374 may be a hollow tube formed from a metal material. The hollow configuration decreases the weight of the tool 312, making it easier for a user to support the tool 312 to engage the cable. The hollow configuration also enables a clamp 550 to be positioned within the tube 374. The tube 374 is selectively movable relative to the clamp 550, as will be discussed below. In other embodiments, the tube 374 may be otherwise constructed. The tube 74 further includes indicia or markings (not shown in this embodiment but shown relative to FIG. 4 at element 94) along the channel axis 366 which indicate a plurality of strip lengths corresponding to the positions of the tube 374. The forward most visible indicia 94a (FIG. 4) may indicate the strip length obtained with that position of the tube 374. In some embodiments, the tube 374 may be sized to allow for strips between 1 inch and 6 inches. In other embodiments, the tube 374 may be longer or shorter. The tube 374 may be removably coupled to the pass-through portion 350 and may be removed when a longer length of cable needs to be stripped.

With reference to FIGS. 28-29, the depth stop system 342 further includes a clamp assembly 560 including the clamp 550 and an actuator assembly 570 coupled to the clamp 550. The actuator assembly 570 includes an actuator or knob 574 and a shaft 578 fixedly coupled to and extending from the actuator 574. The shaft 578 includes a threaded portion 582 that is matingly received within a threaded aperture 586 (or bore) of the clamp 550. The actuator 574 is accessible to a user outside of the main body 334, while the shaft 578 extends from the actuator 574 through the main body 334 and the axial slot 384 of the tube 374 into the threaded aperture 586 of the clamp 550. The actuator 574 is movable (e.g., rotatable) to move the clamp 550 between a locked position and an unlocked position. In the locked position, the clamp 550 exerts a clamping force against an inner surface of the tube 374. In the unlocked position, the clamp 550 is released from (e.g., exerts a lesser clamping force or is spaced apart from) the inner surface of the tube 374 such that the tube 374 is slidable along the axis 366 to adjust the position of the bearing face of the tube 374. Specifically, as the tube 374 slides along the axis 366, the shaft 578 slides along the axial slot 384. The axial slot 384 limits the range of movement of the tube 374. That is, in the retracted position, the shaft 578 abuts a rear end of the slot 384, and in the extended position, the shaft 578 abuts a front end of the axial slot 384. In this way, at least a portion of the tube 74 remains outside the central channel 54.

Although the depth stop system 342 is used in FIGS. 24-45, in other embodiments, the cable stripping tool 312 may include the depth stop system 42 of FIGS. 3-6 or the modifications to the depth stop system 42 shown in FIGS. 9-13.

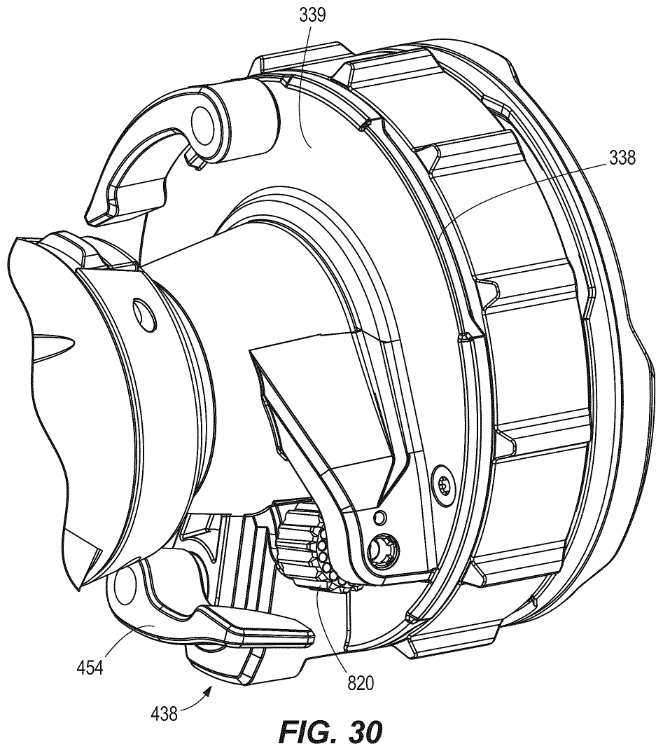

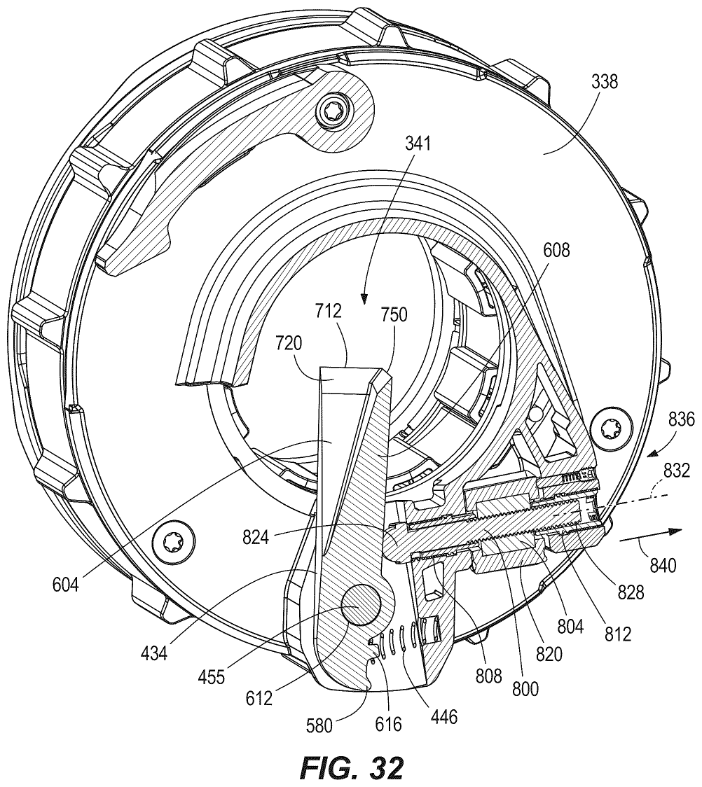

With reference to FIGS. 30-42, the blade assembly 370 may be adjustable and includes a blade 434 and a blade adjustment assembly 438 capable of varying a cutting depth of the blade 434 (e.g., a radial distance between cutting edges 712, 750 of the blade 434 and the channel axis 366). In the illustrated embodiment, a first cutting edge 712 is generally transverse to the axes 343, 366 and a second cutting edge 750 is generally parallel to the axes 343, 366. The blade 434 is adjustable to receive and strip multiple types of cables, for example, cables with different diameters or having different thicknesses of the cable jacket. The blade assembly 370 is adjusted to the appropriate cutting depth to slice the cable jacket without causing any damage to the wires within. In the illustrated embodiment, the blade 434 is pivotally coupled to the bushing 338 for rotation about a pivot axis 442 and is positioned adjacent the side opening 344 of the bushing. A spring 446 (FIG. 32) is positioned between the blade 434 and the bushing 338 pushes against a first end 580 of the blade 434 to bias the blade 434 to rotate toward the axes 343, 366.

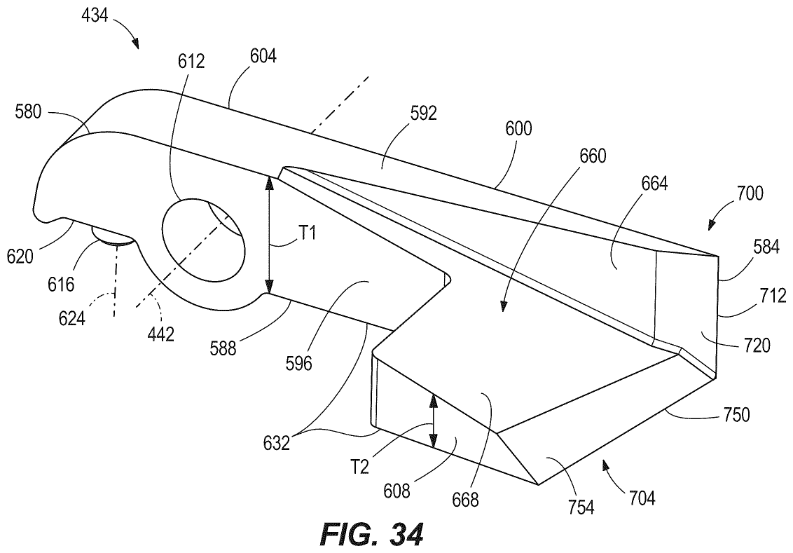

With respect to FIG. 34, the blade 434 includes a body including the first end 580 and a second end 584 (e.g., a working end) opposite the first end 580. The body further includes a first side 588, a second side 592 opposite the first side 588, a third side 596, and a fourth side 600 opposite the third side 596. The body includes a first leg 604 that extends along a length of the body and a second leg 608 that extends laterally from the first leg 604. The second leg 608 is on the third side 596 of the body.

Further with respect to FIG. 34, an aperture 612 extends through the body (and specifically the first leg 604) between the third side 596 and the fourth side 600. A projection 616 extends from the first end 580. The projection 616 supports the spring 446. In the illustrated embodiment, the projection 616 extends from a first surface 620 of the first leg 604 on the first side 588. An axis 624 of the projection 616 is generally perpendicular to the pivot axis 442 extending through the aperture 612.

The first leg 604 and the second leg 608 collectively define a second surface 632 on the first side 588 of the body. In the illustrated embodiment, the second surface 632 is offset from the first surface 620. In other embodiments, the first and second surfaces 620, 632 may be aligned. With respect to FIG. 36, the second surface 632 defines a plane 636 on the first side 588. The plane 636 is positioned at a first angle 640 relative to a plane 644 defined by the fourth side 600. The plane 636 is also positioned at a second angle 648 relative to a plane 652 that is perpendicular to and intersecting the plane 644 of the fourth side 600. The first angle 640 is 80 degrees and the second angle 648 is 10 degrees in the illustrated embodiment, but in other embodiments, the first angle 640 may be between the 75 degrees and 85 degrees and the second angle 648 may be between 5 degrees and 15 degrees.

With renewed reference to FIG. 34, the body defines a maximum thickness T1 and a second thickness T2 that is less than the maximum thickness T1 thereby creating a recessed area 660 of the body having a recess wall 664 and a recessed surface 668. The recessed area 660 encompasses a portion of the first leg 604 and the entire second leg 608. The recess wall 664 is positioned on the first leg 604. The recessed surface 668 encompasses a portion of the first leg 604 and a portion of the second leg 608. The second thickness T2 is not uniform. The recessed area 660 ensures the scrap cable jacket is ejected through the side opening 344 of the bushing 338.

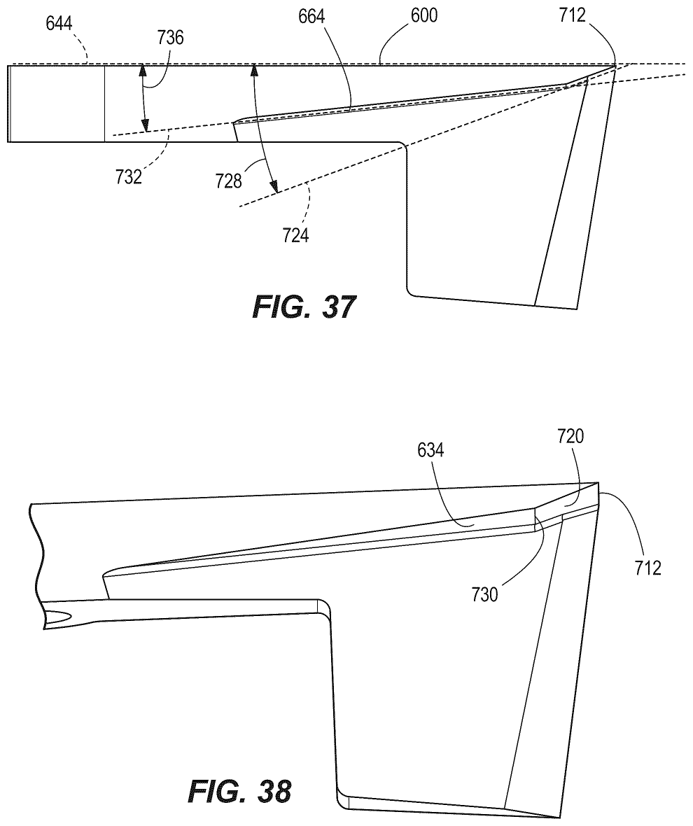

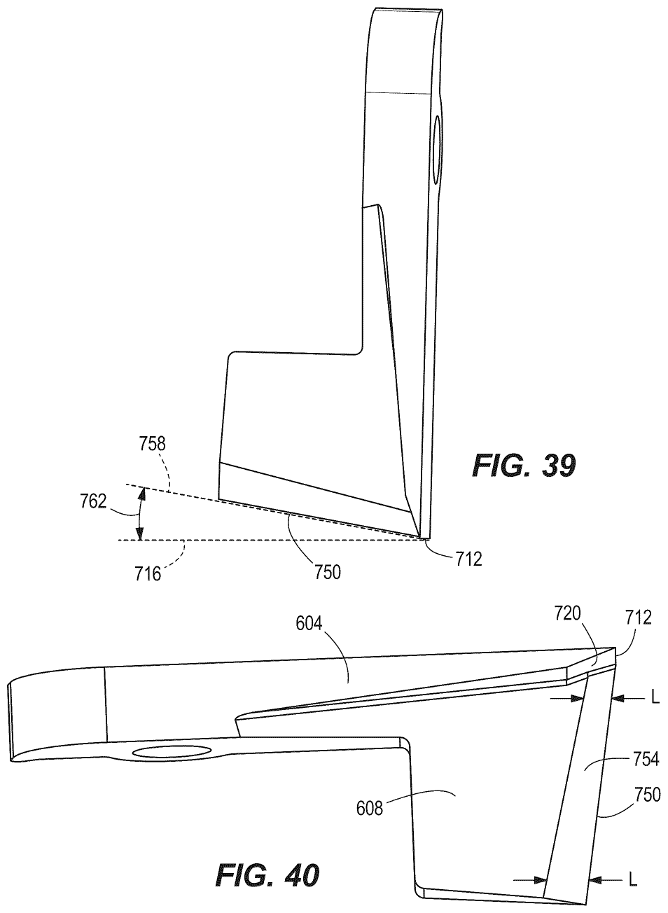

Further with respect to FIG. 34, the working end 584 includes a first blade portion 700 and a second blade portion 704. The first blade portion 700 is supported by the first leg 604. With respect to FIGS. 37-38, the first blade portion 700 has a first cutting edge 712 that extends in a plane 716 (FIGS. 39 and 42), which is generally perpendicular to the plane 644 of the fourth side 600, and a first cutting face 720 extending from the first cutting edge 712 towards the first end 580. The first cutting face 720 extends in a plane 724 (FIG. 37) that is positioned at a third angle 728 relative to the plane 644 of the fourth side 600. In the illustrated embodiment, the third angle 728 is 20 degrees, but in other embodiments, the third angle 728 may range from 15 degrees to 25 degrees. The recess wall 664 extends from the third side 596 toward the fourth side 600 to the first cutting face 720. In the illustrated embodiment, there is a step 730 (FIG. 38) between the first cutting face 720 and the recess wall 664, although the step 730 may be omitted in other embodiments. The recess wall 664 extends in a plane 732 that is positioned at a fourth angle 736 (FIG. 37) relative to the plane 644 of the fourth side 600. In the illustrated embodiment, the fourth angle 736 is 6 degrees, but in other embodiments, the fourth angle 736 may range from 3 degrees to 9 degrees. The third angle 728 pulls the tool 312 forward for a continuous strip, while the fourth angle 736 guides the scrap cable jacket without breaking it and minimizes debris.

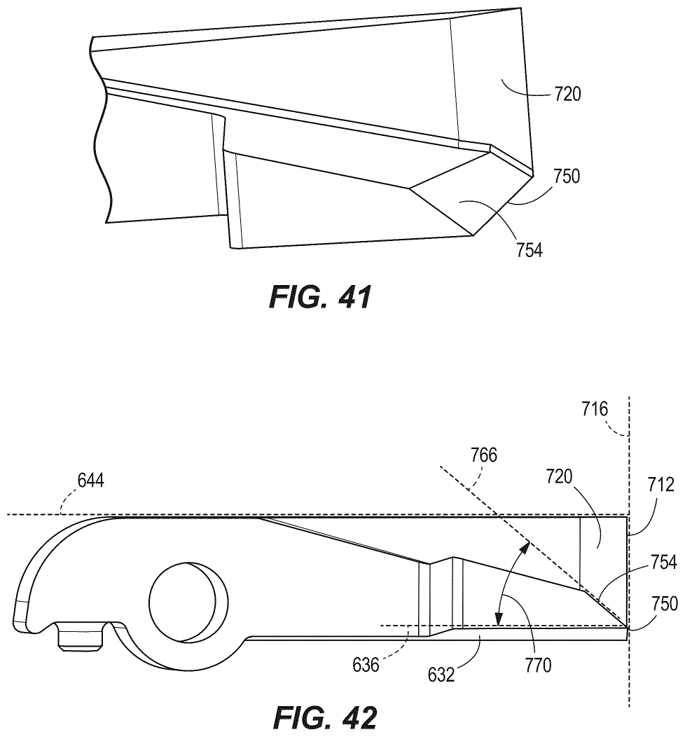

The second blade portion 704 has a second cutting edge 750 and a second cutting face 754. The second blade portion 704 extends along the first leg 604 and the second leg 608. The second cutting edge 750 extends from the first cutting edge 712 along a maximum width of the body. Also, with respect to FIG. 39, the second cutting edge 750 extends in a plane 758, which is positioned at a fifth angle 762 relative to the plane 716 defined by the first cutting edge 712. As shown, the fifth angle 762 is 10 degrees, but in other embodiments, the fifth angle 762 may range from 5 degrees to 15 degrees. As shown in FIG. 40, the second cutting face 754 extends from the first cutting edge 712 along the width of the body. The second cutting face 754 has a first end adjacent to the first cutting edge 712 and a second end opposite the first end. The second cutting face 754 has a first length L1 at its first end and a second length L2 at its second end. The first length L1 is less than the second length L2. The length of the second cutting face 754 gradually increases from the first length L1 to the second length L2. With respect to FIGS. 41 and 42, the second cutting face 754 extends in a plane 766 that is positioned at a sixth angle 770 relative to the plane 636 of the first side 588. In the illustrated embodiment, the sixth angle 770 is 40 degrees, but in other embodiments, the first angle may range from 35 degrees to 45 degrees. The sixth angle 770 guides the scrap cable jacket without breaking it and minimizes debris. The configuration of the second cutting face 754 lifts the scrap cable jacket out of bushing 338 while minimizing resistance.

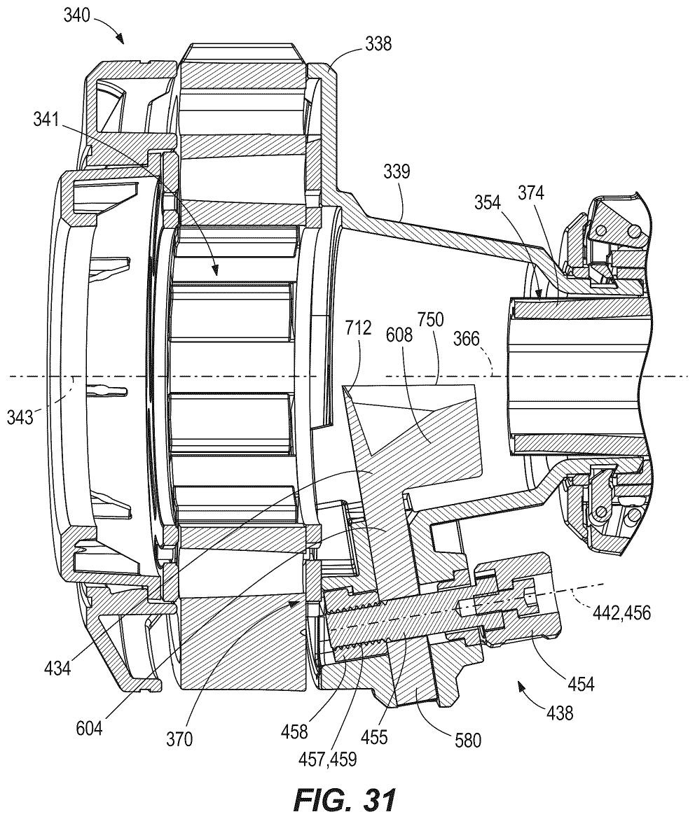

Returning to FIGS. 31, the blade adjustment assembly 438 includes a lever 454 and a shaft 455 (e.g., pin) fixedly coupled to and extending from the lever 454. The lever 454 is disposed on the outside of the bushing 338 and accessible by an operator. The lever 454 is pivotable about an axis 456 that extends along a length of the shaft 455. The shaft 455 includes a threaded portion 457. The shaft 455 extends through the aperture 612 in the blade 434 and into a clamp 458 (e.g., nut, bushing, flange, etc.) supported by the bushing 338. Accordingly, the axis 456 of the shaft 455 is coincident with the pivot axis 442 of the blade 434. In particular, the threaded portion 457 is matingly coupled to a threaded aperture 459 of the clamp 458. The lever 454 is movable (rotatable) between a locked position and an unlocked position. In the locked position, the blade 434 is clamped between the clamp 458 and the main body 339 of the bushing 338. In the unlocked position, the blade 434 is adjustable (e.g., movable or pivotable) relative to the bushing 338 about the axes 442, 456. Rotation of the lever 454 about the axis 456 causes the lever 454 to move toward the clamp 458, clamping the blade 434 between the clamp 458 and the bushing 338.

With particular reference to FIG. 32, the blade adjustment assembly 438 further includes a support member 800 (e.g., a lifting screw), a first bushing threadably 804 engaged with the support member 800, a second bushing 808 threadably engaged with the support member 800, a third bushing 812 threadably engaged with the support member 816, and a knob or dial 820 fixedly coupled to the first bushing 804. The support member 800 is supported by and linearly movable relative to the bushing 338. The support member 800 includes a first end 824, a second end 828 opposite the first end 824, and an axis 832 extending between the first end 824 and the second end 828. The axis 832 is generally transverse to the axes 343, 366. The support member 800 includes a threaded interface extending along at least a portion of the length between the first end 824 and the second end 828. The first bushing 804 defines a threaded interface that matingly engages the threaded interface of the support member 800. The second bushing 808 and the third bushing 812 are supported by the bushing 338 and each includes a threaded interface that matingly engages the threaded interface of the support member 800. Because the knob 820 is fixedly coupled to the first bushing 804, with the lever 454 in the unlocked position, rotation of the knob 820 causes rotation of the first bushing 804, which in turn causes the support member 800 to rotate about the axis 832 to linearly move along the axis 832 relative to the blade 434 to change the cutting depth. When the knob 820 is rotated in a first direction, the support member 800 linearly moves in a first direction 836, such that the first end 824 of the support member 800 moves toward the blade 434. When the knob 820 is rotated in a second direction, the support member 800 linearly moves in a second direction 840 such that the first end 824 moves away from the blade 434. The first end 580 of the blade 434 defines a stop. That is, when the blade 434 is pivoted to the extent that the stop engages a wall of the bushing 338, the blade 434 cannot be pivoted any further away from the axes 343, 366. The spring 446 biases the blade 434 into engagement with the support member 800. The spring 446 and the support member 800 provide a secondary support to reduce wiggle or play of the blade 434 during operation.

In operation, the lever is 454 is moved from the locked position to the unlocked position. Then the knob 820 is rotated in either the first direction or second direction to adjust the position of the support member 800, and thus the blade 434. In other words, rotation of the blade 434 about the axes 442, 456 varies a radial distance between the axes 343, 366 and the first cutting edge 712. Once the blade 434 is the desired position, the lever 454 is moved from the unlocked position back to the locked position.

In some circumstances, the blade 434 may need to be removed from the bushing 338. A user may remove the lever 454 from the shaft 455 from the blade 434 and then unthread the shaft 455 from the clamp 458 to remove the lever 454. The blade 434 can then be lifted away from the bushing through a slot 850 in bushing 338. The blade 134 may then be maintained, repaired, or replaced with a new blade.

Although the blade assembly 370 is used in FIGS. 24-45, in other embodiments, the cable stripping tool 312 may include the blade assembly 370 of FIGS. 15-18 or the blade assembly 200 of FIGS. 19-23 may be used instead.

With reference to FIG. 27A-27C, the motor 358 drives the gear train 362, which ultimately rotates the bushing 338 relative to a cable received therein. The motor 358 is supported in the motor housing 346 and includes a motor shaft 860 (FIG. 27C) that extends along a motor axis 864 (FIG. 27A) that is parallel to the channel axis 366 and central axis 343 of the bushing 338. Additionally, with respect to FIG. 27A, the motor axis 864 is generally parallel to a battery insertion axis 865 of the battery receiving interface 314a. The motor axis 864 is positioned at a non-parallel angle 866 relative to a handle axis 867 extending through the first and second ends 322, 326 of the handle 318. In the illustrated embodiment, the motor axis 684 is positioned at an oblique angle relative to the handle axis 867. The gear train 362 includes a planetary gear arrangement 868, a drive gear 872 that is rotated via the planetary gear arrangement 868, an idler gear 876 that is rotated via engagement with the drive gear 872, and a driven gear 880 (e.g., a spur gear) that is rotated via engagement with the idler gear 876. The spur gear 880 is fixedly coupled to the bushing 338, such that rotation of the spur gear 880 causes rotation of the bushing 338. As shown, the central opening 341 of the bushing 338 and the central channel 354 of the pass-through portion 350 and extend through the spur gear 880. Accordingly, the spur gear 880, and therefore the bushing 338, is rotatable about within the central channel 354 and about the axis 366 thereof.

The planetary gear arrangement 868 is shown in greater detail in FIG. 27C. The planetary gear arrangement 868 includes a ring gear 900 that supports a first planetary stage 904, a second planetary stage 908, and a third planetary stage 912. The first planetary stage 904 includes a first input gear 920, a first plurality of planetary gears 924, and a first carrier 928. The first input gear 920 is coupled to and rotated by the motor shaft 860. The first planetary gears 924 are rotatably coupled to a first carrier 928 and are in engagement with the first input gear 920 and the ring gear 900. The first input gear 920 engages the first planetary gears 924 to rotate the first planetary gears 924 via engagement with the ring gear 900 to rotate the first carrier 928. The second planetary stage 908 includes a second input gear 930 extending from the first carrier 928, a second plurality of planetary gears 934, and a second carrier 938. The second planetary gears 934 are rotatably coupled to the second carrier 938 and are in engagement with the second input gear 930 and the ring gear 900. The second input gear 930 engages the second planetary gears 934 to rotate the second planetary gears 934 via engagement with the ring gear 900 and thereby rotate the second carrier 938. The third planetary stage 912 includes a third input gear 940 extending from the second carrier 938, a third plurality of planetary gears 944, and a third carrier 948. The third planetary gears 944 are rotatably coupled to the third carrier 948 and in engagement with the third input gear 940 and the ring gear 900. The drive gear 872 is fixedly coupled to the third carrier 948. The third input gear 940 engages the third planetary gears 944 to rotate the third planetary gears 944 via engagement with the ring gear 900 and thereby rotate the third carrier 948. Rotation of the third carrier 948 thus rotates the drive gear 872.

The configuration of the motor 358 and the gear train 362 distributes the center of mass of the tool 312 closer to the user's hand. This configuration also decreases the overall tool size. The configuration also allows for a large gear ratio and is more efficient than other motor and gear train configurations.

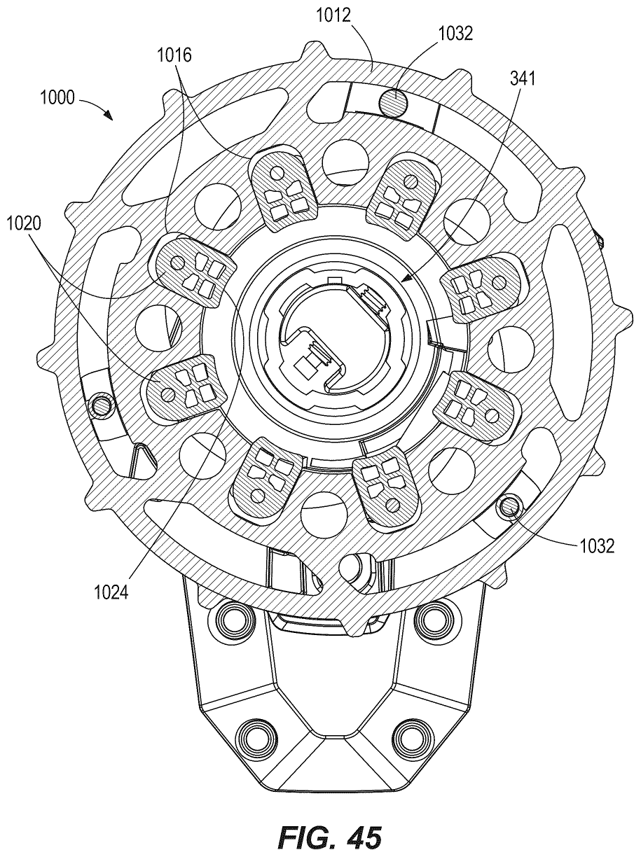

In order to be able to successfully strip multiple types of cables, the bushing 338 is adjustable. That is, the bushing 338 further includes the clamping assembly 340 which is adjustable for holding and guiding cable of different diameters in the central opening 341 of the bushing 338. With reference to FIG. 34-45, the clamping assembly 340 includes a jaw assembly 1000 and a pair of guide plates 1004 on either side of the jaw assembly 1000. The clamping assembly 340 defines a portion of the central opening 341 of the bushing 338. Each of the pair of guide plates 1004 includes a set of slots 1008 extending through the guide plate 1004. In the illustrated embodiment, the slots 1008 extend fully through the guide plate 1004. The jaw assembly 1000 includes a jaw carrier 1012 having a plurality of cradles 1016 (FIG. 45) and a plurality of jaws 1020 each movably supported in one of the plurality of cradles 1016. Each jaw 1020 includes at least one clamp surface 1024 and a pair of pins 1028 (only one of each pair of pins 1028 is shown herein) extending from opposite ends of the jaws 1020. In the illustrated embodiment, the clamping assembly 340 is secured to the main body 339 by a pair of shafts 1032. The shafts 1032 extend through openings in the main body 339 and the guide plates 1004. In some embodiments, the shafts 1032 are fasteners such as bolts or screws having a flanged head and a threaded portion. In other embodiments, the shafts may be otherwise secured to the main body 339. In other embodiments, the clamping assembly 340 may be coupled to the main body 339 in other ways, for example, using detent pins or snap rings.

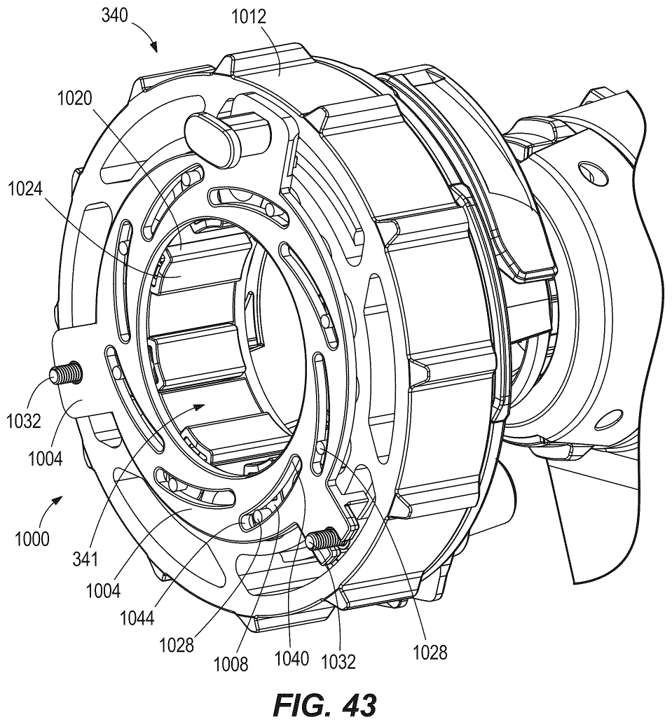

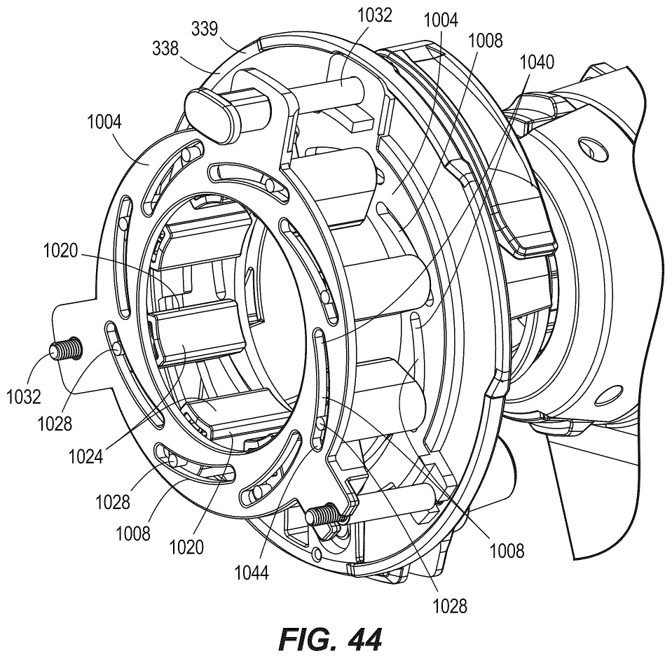

With reference to FIGS. 43 and 44, when the clamping assembly 340 is assembled to the main body 339, the guide plates 1004 are coupled to the main body 339 to rotate therewith. In the illustrated embodiment, the shafts 1032 secure the guide plates 1004 to rotate with the main body 339. The jaw assembly 1000 is positioned between the pair of guide plates 1004. The jaw carrier 1012 rotates with respect to the main body 339 and the guide plates 1004. In the illustrated embodiment, the jaw assembly 1000 includes eight cradles 1016 and eight jaws 1020. The cradles 1016 are circumferentially spaced about the central axis 343 and are evenly spaced.

Each jaw 1020 is coupled to an associated one of the slots 1008 in each of the guide plates 1004. Specifically, each jaw 1020 is disposed between the guide plates 1004 with the pins 1028 positioned in the slots 1008. The cradles 1016 allow for sliding movement of the jaws 1020 in a direction substantially toward the central axis 343. In other words, the jaws 1020 are movable within the cradles 1016 in a radial direction with respect to the central axis 343 and are prevented from moving circumferentially relative to the jaw carrier 1012 by the cradles 1016. The cradles 1016 support the jaws 1020 to maintain an orientation of the jaws 1020 with the clamp surface 1024 generally facing the central axis 343. In some embodiments, the jaws 1020 may rotate slightly within the cradles 1016 to attune the clamp surfaces 1024 to engage the outer profile of the cable 100.

With reference to FIGS. 43 and 44, the slots 1008 are arcuate slots and define a pathway including a circumferential component and a radial component. The jaws 1020 are configured to travel along the pathway relative to the guide plates 1004. In the illustrated embodiment, the guide plates 1004 are identical and, when assembled, the slots 1008 of each guide plate 1004 are aligned. Each slot 1008 extends between a first path end 1040 and a second path end 1044, and the jaws 1020 travel along the pathway between the first path end 1040 and the second path end 1044. The first path end 1040 is positioned at a first distance from the central axis 343, measured radially. The second path end 1044 is positioned at a second distance from the central axis 343, measured radially. The first distance and the second distance are not equal to each other or, in other words, the pathway has radial variation; the jaws 1020 move radially when the pins 1028 travel along the slots 1008. In the illustrated embodiment, the second distance is smaller than the first distance so the jaws 1020 move radially inwardly as the pins 1028 traverse the slot 1008. Thus, the clamp surfaces 1024 are able to move radially and enter the central opening 341 to engage the cable 100. In the illustrated embodiment, the curve of the slots 1008 is such that the radial distance between the central axis 343 and the jaws 1020 decreases constantly as the pins 1028 travel along the pathway. In other embodiments, the slots 1008 may have other shapes. In some embodiments, the radial distance may remain constant for a portion of the pathway. In some embodiments, the radial distance may both increase and decrease as the pin 1028 traverses the slot 1008 from the first path end 1040 to the second path end 1044. Still further shapes may be used to provide different clamping styles.

To operate the clamping assembly 340, the jaw carrier 1012 is rotated about the central axis 343 relative to the main body 339 and to the guide plates 1004. Rotation of the jaw carrier 1012 causes the jaws 1020 to move radially relative to the central axis 343. Specifically, the jaw carrier 1012 rotates the cradles 1016 about the central axis 343, and the cradles 1016 apply a tangential force to the jaws 1020. Since the jaws 1020 are mounted in the slots 1008 of the adjacent guide plates 1004, the jaws 1020 are carried radially by the slots 1008 as the jaw carrier 1012 rotates and moves the jaws 1020 circumferentially. The cradles 1016 maintain the orientation of the jaws 1020 to keep the clamp surface 1024 pointed toward the central axis 343. In the illustrated embodiment, counter-clockwise rotation of the jaw carrier 1012 about the central axis 343 (when viewed along the axis from the front end 332) causes the jaws 1020 to move radially inward and extend into the central opening 341. The clamping assembly 340 is movable between an unclamped or retracted configuration and one or more clamped or extended configurations, in which at least a portion of the jaws 1020 extend into the central opening 341 to engage the cable 100. The clamping assembly 340 is continuously movable between the unclamped configuration and a fully clamped configuration through a series of intermediate clamped configurations.

The clamping assembly 340 allows an operator to clamp different sizes of conduit by rotating the jaw carrier 1012 until the clamp surfaces 1024 of the jaws 1020 engage the cable jacket 101 of the cable 100. The fully clamped configuration may correspond to a cable 100 with a small diameter. While not discussed herein, the clamping assembly 340 includes a latch assembly configured to maintain the position of the jaw assembly 1000 once the desired configuration has been reached. The latch assembly may use any one of a number of known methods and may engage the jaw carrier 1012 or other portions of the jaw assembly 1000.

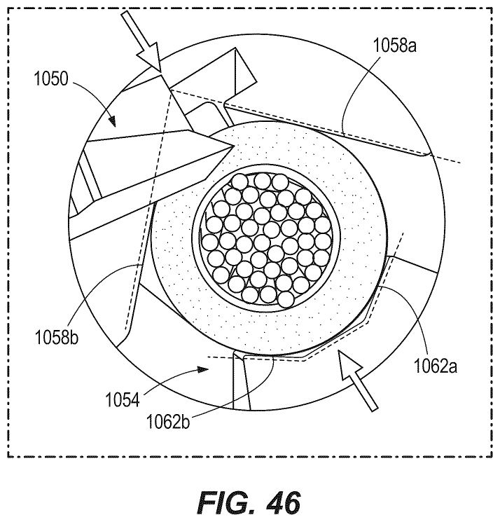

In another embodiments, such as that shown in FIG. 46, the jaws 1020 may be replaced by a V-shaped jaw 1050 and a U-shaped jaw 1054 opposite the V-shaped jaw 1050 relative to the channel axis 366. That is, the slots 1008 of the guide plates 1004 may be modified to advance and retract legs 1058a, 1058b, 1062a, 1062b of the V-shaped jaw 1050 and the U-shaped jaws 1054, such the legs 1058a, 1058b, 1062a, 1062b engage the cable jacket of the cable. In still other embodiments, the jaws 1020 may be replaced by a two V-shaped jaws 1050 on opposite sides of the channel axis 366. The V-shaped jaws 1050 and/or U-shaped jaws 1054 may reduce friction and increase compatibility with higher friction cable materials (EPR).

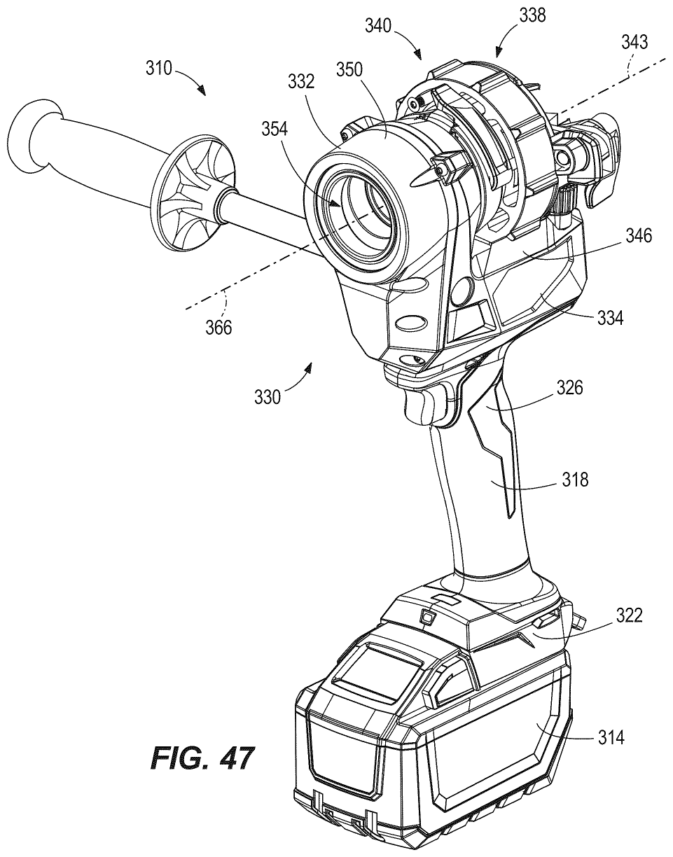

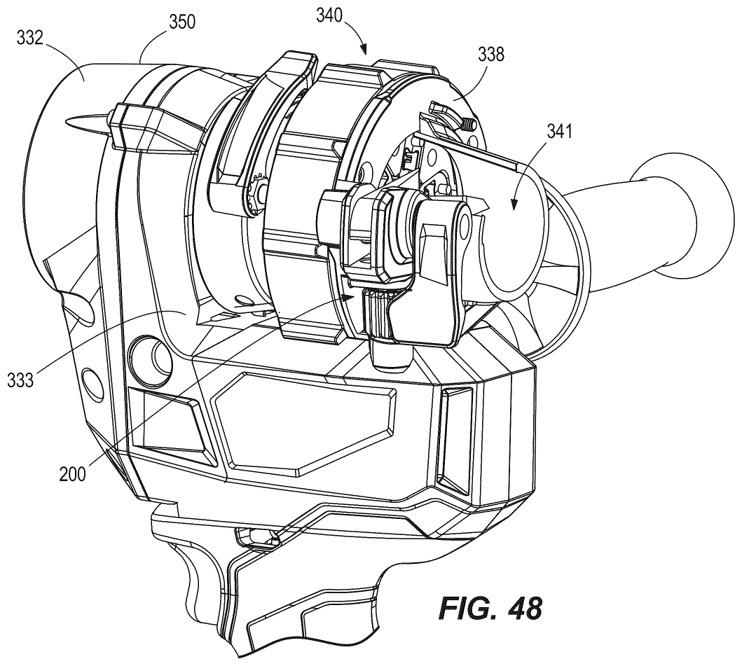

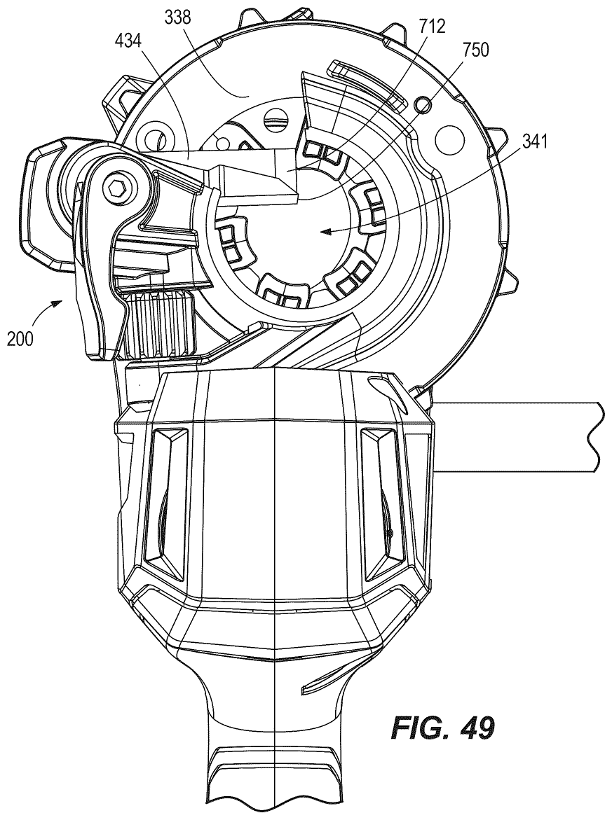

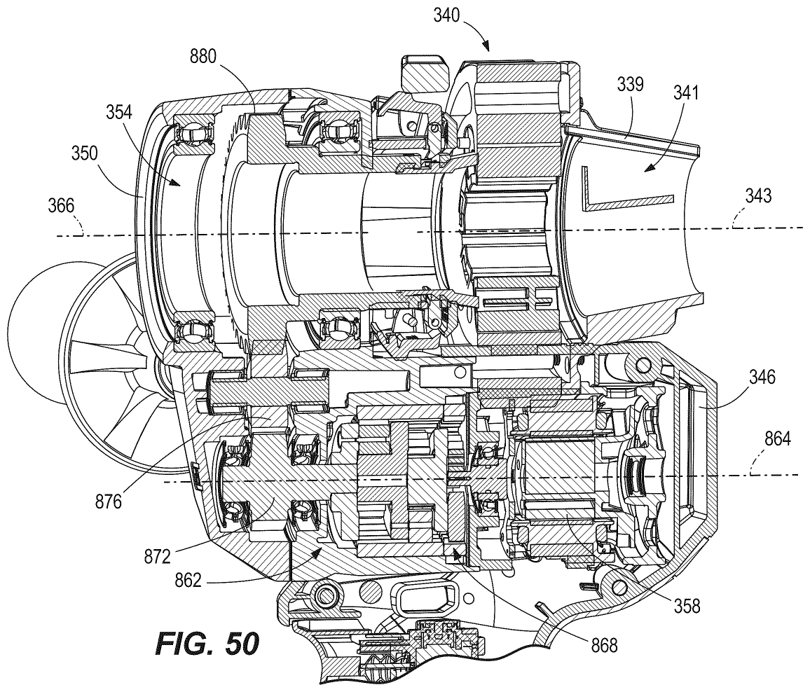

The cable stripping assembly 310′ of embodiment of FIGS. 47-50 is similar to the cable stripping assembly 310 of FIGS. 24-45. Therefore, like reference numerals will be used for like structure and only the differences discussed herein. In the embodiment of FIGS. 24-45, the adjustable bushing 338 is coupled to the front end 332 of the head 330 (e.g., pass-through portion 350) of the tool 312. Referring to FIGS. 47-50, the adjustable bushing 338 is coupled to the head 330 (e.g., pass-through portion 350) at or adjacent to the rear end 333.

To this end, the central channel 354 of the pass-through portion 350 is accessible at the front end 332 of the head 330, while the adjustable bushing 338 is coupled to and extends rearwardly the pass-through portion 350 on the rear end 333. As shown, the clamping assembly 340 is positioned adjacent to the rear end 333 of the pass-through portion 350 and is positioned between the pass-through portion 350 and a rear end of the bushing 338. The central opening 341 of the bushing 338 extends along the length of the bushing 338. The side opening 344 and the depth stop system 342 of FIGS. 24-45 are omitted. The blade assembly 370 is positioned between the clamping assembly 340 and the rear end of the bushing 338. A cable end is fed into the central channel 354 at the front end 332 of the pass-through portion 350 and moves along a channel axis 366 through the central opening 341 of the bushing 338. Because the central opening 341 remains open at the rear end of the bushing 338, the scrap cable jacket can be guided away from the tool 312 through the central opening 341 at the rear end of the bushing 338 as the tool 312 is advanced along the cable. The embodiment of FIGS. 47-50 is preferred for stripping greater than six inches of the cable. Specifically, this embodiment is preferred for stripping 12 inches to 36 inches of the cable (e.g., tree wire).

Like the embodiment of FIGS. 24-45, the motor 358 (FIG. 27A) is positioned in the motor housing 346 and is electrically coupled to the battery 14 to transmit rotation to a gear train 362 (FIG. 27A). The adjustable bushing 338 is coupled to the gear train 362 such that rotation of the motor 358 is transmitted to the bushing 338 through the gear train 362. The configurations of the motor 358 and gear train 362 are the same as discussed above with respect to FIGS. 24-45. Additionally, the clamping assembly 340 is the same as discussed above with respect to FIGS. 24-45, although the clamping assembly 340 may be used instead. The cable stripping assembly 310 of FIGS. 47-50 has the blade assembly 200 of FIGS. 19-23, but in other embodiments any of the other blade assemblies discussed herein may be used instead.

Various other features are set forth in the following claims.

What is claimed is:

1. A cable stripping assembly for removing a cable jacket from a cable, the cable stripping assembly comprising:
a cable stripping tool including
a housing including a head and a handle, the head including a central opening defining a central axis and configured to receive a cable, the handle extending from the head, and
a motor disposed in the head, the motor having a motor shaft extending along a motor axis that is parallel to the central axis;
an adjustable bushing coupled to the head and having a central opening that is in communication with the head of the housing and extends along the central axis, wherein actuation of the motor drives the adjustable bushing to rotate; and
a blade mounted to the adjustable bushing and configured to partially extend into the central opening of the adjustable bushing to engage the cable.

2. The cable stripping assembly of claim 1, wherein the cable stripping tool also includes a gear train positioned within the housing, and wherein the motor actuates the gear train to rotate the adjustable bushing.

3. The cable stripping assembly of claim 2, wherein the gear train includes a planetary gear arrangement driven by the motor, a drive gear driven by the planetary gear arrangement, an idler gear driven by the drive gear, and a driven gear driven by the idler gear, the driven gear fixedly coupled to adjustable bushing.

4. The cable stripping assembly of claim 1, wherein the handle includes a battery pack receptacle configured to receive a battery pack for powering the motor, the battery pack receptacle having a battery pack insertion axis that is parallel to the motor axis.

5. The cable stripping assembly of claim 1, further comprising a depth stop system including a tube movably coupled to the head along the central axis.

6. The cable stripping assembly of claim 1, wherein the blade has a first cutting edge and a second cutting edge.

7. A cable stripping assembly for removing a cable jacket from a cable, the cable stripping assembly comprising:
a cable stripping tool including
a housing including a head and a handle, the head including a central opening defining a central axis and configured to receive a cable, the handle extending from the head, and
a motor disposed in the housing;
an adjustable bushing coupled to the head and having a central opening that is in communication with the head of the housing and extends along the central axis, wherein actuation of the motor drives the adjustable bushing to rotate;
a blade mounted to the adjustable bushing and configured to partially extend into the central opening of the adjustable bushing to engage the cable; and
a depth stop system supported by the head, the depth stop system including
a tube that is receivable and movable within the central opening between a first position and an second position, and
a clamp assembly configured to lock the tube in the first position and the second position relative to the head.

8. The cable stripping assembly of claim 7, wherein the tube is slidable between a plurality of positions between the first position and the second position.

9. The cable stripping assembly of claim 7, wherein the clamp assembly includes a clamp positioned within the tube and an actuator assembly accessible from outside the housing and movably coupled to the clamp.

10. The cable stripping assembly of claim 9, wherein the actuator assembly moves the clamp between a locked position and an unlocked position, wherein in the locked position, the clamp exerts a clamping force against an inner surface of the tube, and wherein in the unlocked position, the clamp is released from the inner surface of the tube.

11. The cable stripping assembly of claim 9, wherein the tube includes a slot, wherein the actuator assembly extends through the slot, and wherein the actuator assembly is adjacent to a rear end of the slot while in the first position and is adjacent to a front end of the slot while in the second position.

12. The cable stripping assembly of claim 7, wherein the blade has a first cutting edge and a second cutting edge.

13. A cable stripping assembly for removing a cable jacket from a cable, the cable stripping assembly comprising:
a cable stripping tool including
a housing including a head and a handle, the head including a central opening defining a central axis and configured to receive a cable, the handle extending from the head, and
a motor disposed in the housing;
an adjustable bushing coupled to the head and having a central opening that is in communication with the head of the housing and extends along the central axis, wherein actuation of the motor drives the adjustable bushing to rotate; and
a blade mounted to the adjustable bushing and configured to partially extend into the central opening of the adjustable bushing to engage the cable, the blade having a body including
a first end,
a second end opposite the first end, the second end extending into and movable relative to the central opening,
a first leg extending between the first end and the second end,
a second leg extending laterally from the first leg,
a first cutting edge positioned at the second end and defined by the first leg, the first cutting edge extending in a first plane, and
a second cutting edge positioned at the second end and extending from the first cutting edge along the first leg and the second leg, the second cutting edge extending in a second plane that is positioned at a non-perpendicular angle relative to the first plane.

14. The cable stripping assembly of claim 13, wherein the non-perpendicular angle is between 5 degrees and 15 degrees.

15. The cable stripping assembly of claim 13, wherein the non-perpendicular angle is a first non-perpendicular angle, wherein the body also includes a first side, a second side opposite the first side, a third side, and a fourth side opposite the third side, and wherein the first leg and the second leg collectively define a surface on the first side that is positioned at a second non-perpendicular angle relative to a third plane defined by the fourth side.

16. The cable stripping assembly of claim 15, wherein the surface on the first side is positioned at a third non-perpendicular angle relative to a fourth plane, wherein the fourth plane is perpendicular to and intersects the third plane defined by the fourth side, and wherein the third non-perpendicular angle being between 5 degrees and 15 degrees.

17. The cable stripping assembly of claim 16, wherein the body of the blade also includes a first cutting face extending toward the first end from the first cutting edge and a second cutting face extending toward the first end from the second cutting face, the first cutting face extending at a first angle relative to the third plane, and the second cutting face extending at a second angle relative to the surface of the first side.

18. The cable stripping assembly of claim 17, wherein the first angle is between 15 degrees and 25 degrees, and wherein the second angle is between 35 degrees and 45 degrees.

19. The cable stripping assembly of claim 17, wherein the body of the blade also includes a recessed area having a recess wall and a recess surface that is recessed relative to the second side, the recess wall extending from the first cutting face toward the first end at a third angle, the recess surface extending from the second cutting face toward the first end.

20. The cable stripping assembly of claim 19, wherein the third angle is between 3 degrees and 9 degrees.
